(19) United States
(12) Patent Application Publication
(10) Pub. No.: US 2014/0078256 A1
(43) Pub. Date: Mar. 20, 2014

(54) PLAYBACK DEVICE, TRANSMISSION DEVICE, PLAYBACK METHOD AND TRANSMISSION METHOD

(71) Applicant: Panasonic Corporation, Osaka (JP)

(72) Inventors: Tomoki Ogawa, Osaka (JP); Hiroshi Yahata, Osaka (JP)

(21) Appl. No.: 14/119,516

(22) PCT Filed: Dec. 28, 2012
(86) PCT No.: PCT/JP2012/008444

§ 371 Date: Nov. 22, 2013

Related U.S. Application Data
(60) Provisional application No. 61/580,859, filed on Dec. 28, 2011.

(51) Int. Cl. H04N 13/00

(52) U.S. Cl. CPC H04N 13/0007
USPC 348/43

(57) ABSTRACT

The playback device receives a first transport stream including first-type and second-type video images that have been encoded; decodes the video images; stores the decoded video images into a first buffer; determines whether each of the video images is the first-type video image or the second-type video image; receives a second transport stream including a third-type video image that has been encoded and that differs from the first-type video image in terms of viewpoint; decodes the third-type video image; stores the decoded third-type video image into a second buffer; when the video image is determined to be the first-type video image, performs 3D playback using the first-type video image stored in the first buffer and the third-type video image stored in the second buffer; and when the video image is determined to be the second-type video image, performs 2D playback using the second-type video image stored in the first buffer.

### TECHNICAL FIELD

The present invention relates to a technology for playing back 3D video images and 2D video images.

### BACKGROUND ART

In recent years, various methods have been proposed for transmitting and receiving video images used to display 3D video images. Hereinafter, displaying of 3D video images is also referred to as 3D playback, and displaying of 2D video images is referred to as 2D playback.

For example, Patent Literature 1 proposes a method for separately generating a transport stream including left-view video images and a transport stream including right-view video images, and transmitting the transport streams via different transmission channels. In this method, a playback device receives the transport streams via the different channels, and stores the left-view video images into a frame buffer, and the right-view video images into a different frame buffer. Then, the playback device alternately switches the reading location from which video images are read for display between the frame buffer and the different frame buffer according to a display cycle (e.g., 1/120 seconds). This enables playback of 3D video images.

### CITATION LIST

### Patent Literature

### [Patent Literature 1]

WO 2010/053246

### SUMMARY OF INVENTION

### Technical Problem

However, in the current technology for broadcasting a 3D program, video images constituting the main part of the program are displayed stereoscopically (hereinafter, also referred to as 3D display) whereas other video images such as those constituting a commercial message are displayed monoscopically (hereinafter, also referred to as 2D display). In other words, in the current technology for broadcasting a 3D program, 2D display and 3D display are both performed. Accordingly, in the technology disclosed in Patent Literature 1, video images other than those constituting the main part of a 3D program need to be transmitted via two different transmission channels. This forces the playback device to display the video images by alternately switching the frame buffers even though these video images transmitted via the different transmission channels are the same video images (i.e., video images other than the main part of the 3D program). It is redundant to store the same video images in two different frame buffers and display the video images by alternately switching these frame buffers.

In view of the above problem, the present invention aims to provide a playback device, a transmission device, a playback method, and a transmission method, the playback device being for displaying given video images two-dimensionally without performing a redundant process, the given video images being other than video images constituting the main part of a 3D program and being intended for 2D display.

### Solution to Problem

To achieve the above problem, the present invention provides a playback device comprising: a first reception unit configured to receive a first transport stream, the first transport stream including a series of at least one first-type video image and at least one second-type video image, the first-type video image having been encoded and being used for 3D playback, and the second-type video image having been encoded and being used for 2D playback; a second reception unit configured to receive a second transport stream including at least one third-type video image that has been encoded, the third-type video image differing from the first-type video image in terms of viewpoint and being used with the first-type video image for 3D playback; a first decoding unit configured to decode the first-type video image and the second-type video image in the first transport stream, and to store the first-type video image and the second-type video image thus decoded into a first buffer; a second decoding unit configured to decode the third-type video image in the second transport stream, and to store the third-type video image thus decoded into a second buffer; a determination unit configured to determine, for each video image in the first transport stream, whether the video image is the first-type video image or the second-type video image; and a playback processing unit configured to, when the determination unit determines that the video image is the first-type video image, perform 3D playback with use of the first-type video image stored in the first buffer and the third-type video image stored in the second buffer, and when the determination unit determines that the video image is the second-type video image, perform 2D playback with use of the second-type video image stored in the first buffer.

### Advantageous Effects of Invention

According to the above structure, the playback device performs 2D playback using the second-type video image stored in the first buffer. This eliminates the need for alternately switching the frame buffers. As a result, the playback device can playback (display) the video images intended for 2D display without performing a redundant process.

### BRIEF DESCRIPTION OF DRAWINGS

FIG. 1 shows an example of generating a parallax image consisting of a left-view video image and a right-view video image based on a 2D video image and a depth map.

FIGS. 2A, 2B, and 2C show the usage of a playback device (digital television) 10.

FIG. 3 shows the structure of a digital stream in a transport stream format.

FIG. 4 shows the data structure of a PMT.

FIG. 5A shows the structure of GOPs constituting a video stream, and FIG. 5B shows the data structure of a video access unit.

FIG. 6 shows the structure of a PES packet.

FIG. 7A shows the data structure of TS packets constituting a transport stream, and FIG. 7B shows the data structure of a TS header.

FIG. 8 shows an example of the display of a stereoscopic image.

FIG. 9 shows a Side-by-Side method.

FIG. 10 shows stereoscopic viewing in a multiview encoding method.

FIG. 11 shows the structure of video access units for pictures in a base-view video stream and in a right-view video stream.

FIG. 12 shows the relationship between a PTS and a DTS allocated to each video access unit in a base-view video stream and a dependent-view video stream.

FIG. 13 shows the GOP structure in the base-view video stream and the dependent-view video stream.

FIGS. 14A and 14B each show the structure of a video access unit included in a dependent GOP.

FIG. 15 shows the structure of a video transmission and reception system

FIG. 16 is a block diagram showing the structure of a transmission device 200.

FIG. 17 is a block diagram showing the structure of a playback device 10.

FIG. 18 is a flowchart showing the transmission processing performed by the transmission device 200.

FIG. 19 is a flowchart showing the playback processing performed by the playback device 10.

FIG. 20 is a block diagram showing the structure of a transmission device 200a.

FIG. 21 is a block diagram showing the structure of a playback device 10a.

FIG. 22 is a flowchart showing the playback processing performed by the playback device 10a.

FIG. 23 is a block diagram showing the structure of a transmission device 200b.

FIG. 24 is a block diagram showing the structure of a playback device 10b.

FIG. 25 is a flowchart showing the playback processing performed by the playback device 10b.

FIG. 26 is a block diagram showing the structure of a transmission device 400 according to a commonly-used technology.

### DESCRIPTION OF EMBODIMENTS

### 1. Outline

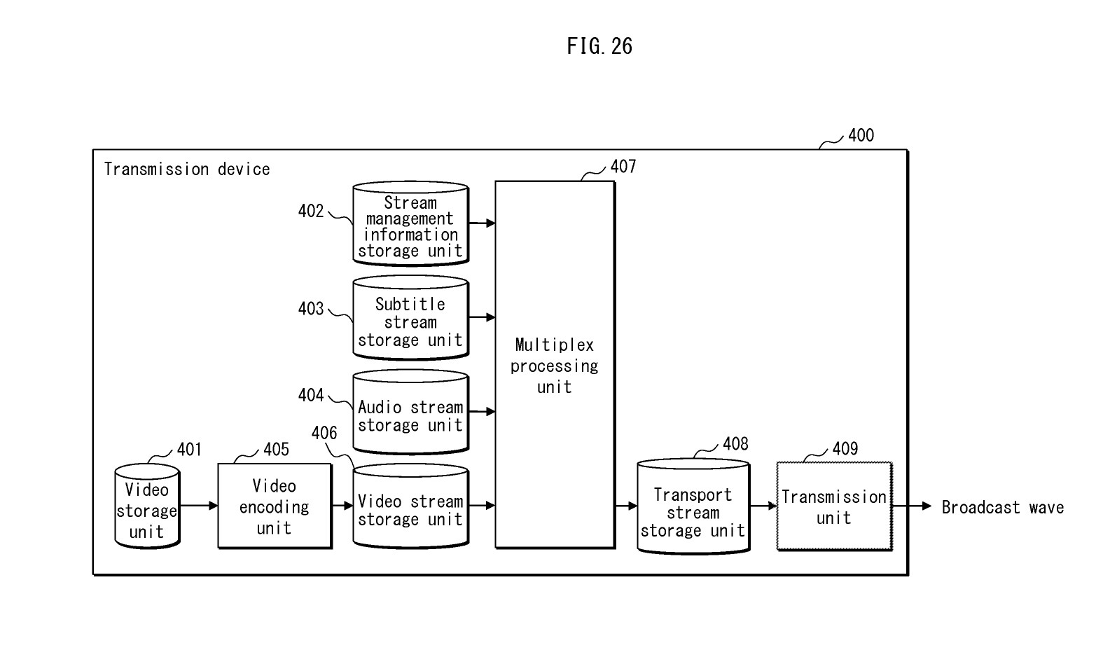

FIG. 26 shows, as an example, a transmission device 400 used in typical broadcasting. As shown in FIG. 26, in the transmission device 400, a video encoding unit 405 generates a video stream by compressing video images which constitute a 2D program and are stored in a video storage unit 401. The compression is performed in a video format corresponding to a broadcasting standard. Upon generating the video stream, the video encoding unit 405 stores the video stream into a video stream storage unit 406. Here, examples of a video format corresponding to a broadcasting standard includes MPEG (Moving Picture Experts Group) 2 Video, MPEG-4 AVC (Advanced Video Coding), and VC1. A multiplex processing unit 407 of the transmission device 400 generates a transport stream by multiplexing the video stream in the video stream storage unit 406 with: information on the 2D program, such as an EIT (Event Information Table), stored in a stream management information storage unit 402; subtitle data stored in a subtitle stream storage unit 403; and audio data stored in an audio stream storage unit 404. Then, the multiplex processing unit 407 stores the generated transport stream into a transport stream storage unit 408. A transmission unit 409 of the transmission device 400 modulates the transport stream stored in the transport stream storage unit 408 in a format appropriate for a broadcast wave, and transmits the modulated transport stream as a broadcast wave. The bit rate of the transport stream transmitted as the broadcast wave differs depending on a radio frequency band or a modulation system usable when the transmission unit 409 transmits the transport stream. For example, the transmission unit 409 can transmit the transport stream with a bit rate of about 17 Mbps in the case of terrestrial broadcasting in Japan, and can transmit the transport stream with a bit rate of about 24 Mbps in the case of satellite broadcasting in Japan.

In typical 2D broadcasting, standards for terrestrial broadcasting defined in Japan and North America include MPEG-2 Video, which is a video compression method. Accordingly, the bit rate (bandwidth) secured for the aforementioned transport stream is mainly used to transmit MPEG-2 Video images. The standards for terrestrial broadcasting are defined by ARIB (Association of Radio Industries and Businesses) in Japan, and by ATSC (Advanced Television System Committee) in North America.

In recent years, broadcasting stations that broadcast 3D programs have been increasing. To achieve 3D display with a typical transport stream, the following three methods are possible.

One method is to broadcast left-view and right-view video images in Side-by-Side method. In this method, one frame of a right-view video signal and one frame of a right-view video signal are compressed horizontally by a factor of ½. Then, the compressed frames are aligned laterally, and transmitted as a single frame. This method is disadvantageous in that the resolution of the video images is reduced by half as compared to a typical 2D broadcast. However, this method allows the transmission device in typical 2D broadcasting as shown in FIG. 26 to realize 3D display by simply replacing 2D video images with Side-by-Side video images. For this reason, some broadcasting stations broadcast 3D programs using the Side-by-Side method.

Another method is to transmit 3D video images with use of MPEG-4 MVC (Multiview Video Coding) instead of the MPEG-2 Video. In this case, however, televisions that only decode typical MPEG-2 Video images cannot perform either 3D display or 2D display. In other words, existing televisions cannot display any video images using this method; therefore, it is commercially difficult to compress video images using this method and transmit the video images via typical broadcast waves.

Yet another method is to reduce the bit rate of typical 2D video images (e.g., reduce the bit rate from 15 Mbps to 10 Mbps), set the 2D video images with the reduced bit rate as left-view video images, and add right-view video images compressed with use of MPEG-2 Video or MPEG-4 AVC to the remaining bandwidth (i.e., the bandwidth that has become available due to the reduction of the bit rate of the 2D video images). This allows typical televisions to display 2D video images by decoding MPEG-2 Video images, and allows televisions that can decode the added right-view video images to display 3D video images. In this case, however, the bit rate of MPEG-2 Video images is reduced in order to secure the bandwidth to which the right-view video images are added. This causes the quality of the video images to be poor as compared to the video images displayed in typical 2D broadcasting.

In view of such problems, another method is proposed, as described above, that separately generates a transport stream including left-view video images and a transport stream including right-view video images, and transmits the transport streams via different transmission channels.

In this method, a television (playback device) receives the transport streams via the different channels, and stores the left-view video images into a frame buffer, and stores the right-view video images into a different frame buffer. Then, the television alternately switches the reading location from which video images are read for display between the frame buffer and the different frame buffer according to a display cycle (e.g., 1/120 seconds). This enables playback of 3D video images. Since the left-view video images and the right-view video images are transmitted via different transmission channels, typical televisions can display 2D video images by receiving only the left-view video images. Also, this method does not require reduction of the bit rate of video images.

However, as described above, the present inventors have found that, in the current technology for broadcasting a 3D program, a redundant process is performed to two-dimensionally display video images irrelevant to the main part of the 3D program, such as a commercial message.

The present inventors have conducted intense study to solve the above problem, and have arrived at the present invention.

One aspect of the present invention is a playback device comprising: a first reception unit configured to receive a first transport stream, the first transport stream including a series of at least one first-type video image and at least one second-type video image, the first-type video image having been encoded and being used for 3D playback, and the second-type video image having been encoded and being used for 2D playback; a second reception unit configured to receive a second transport stream including at least one third-type video image that has been encoded, the third-type video image differing from the first-type video image in terms of viewpoint and being used with the first-type video image for 3D playback; a first decoding unit configured to decode the first-type video image and the second-type video image in the first transport stream, and to store the first-type video image and the second-type video image thus decoded into a first buffer; a second decoding unit configured to decode the third-type video image in the second transport stream, and to store the third-type video image thus decoded into a second buffer; a determination unit configured to determine, for each video image in the first transport stream, whether the video image is the first-type video image or the second-type video image; and a playback processing unit configured to, when the determination unit determines that the video image is the first-type video image, perform 3D playback with use of the first-type video image stored in the first buffer and the third-type video image stored in the second buffer, and when the determination unit determines that the video image is the second-type video image, perform 2D playback with use of the second-type video image stored in the first buffer.

### 2. Embodiment 1

The following describes Embodiment 1 according to the present invention, with reference to the drawings.

2.1 Preparation

First, a brief description is provided on the principles of stereoscopic viewing. Stereoscopic viewing is realized by using an integral imaging method such as a holographic technology or a method using parallax images.

The method of applying a holographic technology is characterized in that objects are recreated stereoscopically and are perceived by humans in exactly the same way as when viewing objects in everyday life. However, while the theoretical groundwork has been established for the generation of moving images with such a technology, the real-time generation of moving images using holography requires a computer capable of performing an enormous amount of calculations as well as a display device having a resolution at which thousands of lines can be drawn with single-millimeter spacing. These are extremely difficult to accomplish with the present technology, and few, if any, examples of commercial realization can be found.

Now, description is provided on the method of using parallax images. Generally, due to the positional difference between the right eye and the left eye, there is a slight difference between an image viewed by the right eye and an image viewed by the left eye. This difference, also called parallax, is used to cause humans to perceive an image stereoscopically. By performing stereoscopic display using parallax images, planar images are perceived by the human eyes as if the images were stereoscopic, by parallax.

This method is advantageous in that stereoscopic viewing can be realized simply by preparing two images of different perspectives, one for the right eye and one for the left eye. Here, the importance lies in ensuring that an image corresponding to the left or right eye is made visible to only the corresponding eye. As such, several technologies, including the alternate frame sequencing method, have been put into practical use.

The alternate frame sequencing method is a method where left-view video images and right-view video images are displayed in alternation along a time axis. The video images displayed in such a manner cause the left and right scenes to overlap each other in the viewer's brain due to an afterimage effect, and thus are perceived as stereoscopic video images.

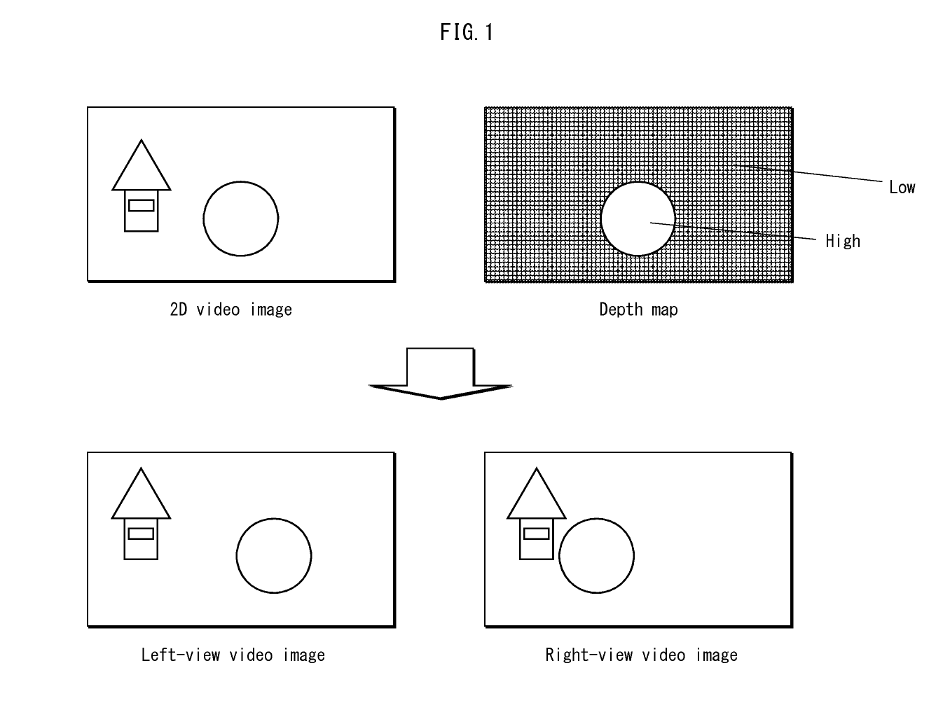

Another method for performing stereoscopic viewing using parallax images, other than the method where images are separately prepared for the right eye and the left eye, is the depth map method. In this method, a depth map which includes depth values of 2D video images in units of pixels is separately prepared, and a player or a display generates parallax images of left-view and right-view video images based on the 2D video images and the depth map. FIG. 1 schematically shows an example of generating a parallax image consisting of a left-view video image and a right-view video image based on a 2D video image and a depth map. The depth map contains a depth value corresponding to each pixel within the 2D video image. In the example of FIG. 1, information indicating high depth is assigned to the round object in the 2D video image according to the depth map, while information indicating low depth is assigned to the other area. This information may be contained as a bit sequence for each pixel, or may be contained as a picture image (such as an image where black indicates low-depth and white indicates high-depth). The parallax image can be created by adjusting the parallax amount of the 2D video image according to the depth values in the depth map. In the example of FIG. 1, the left-view and the right-view video images are created in which the pixels of the round object have high parallax while the pixels of the other area have low parallax. This is because the round shape in the 2D video image has high depth values while the other area has low depth values. The left-view and right-view video images so created are then used for stereoscopic viewing by performing display using the alternate frame sequencing method or the like.

This concludes the description on the principles of stereoscopic viewing.

Next, description is provided on the usage of a playback device 10 according to the present embodiment.

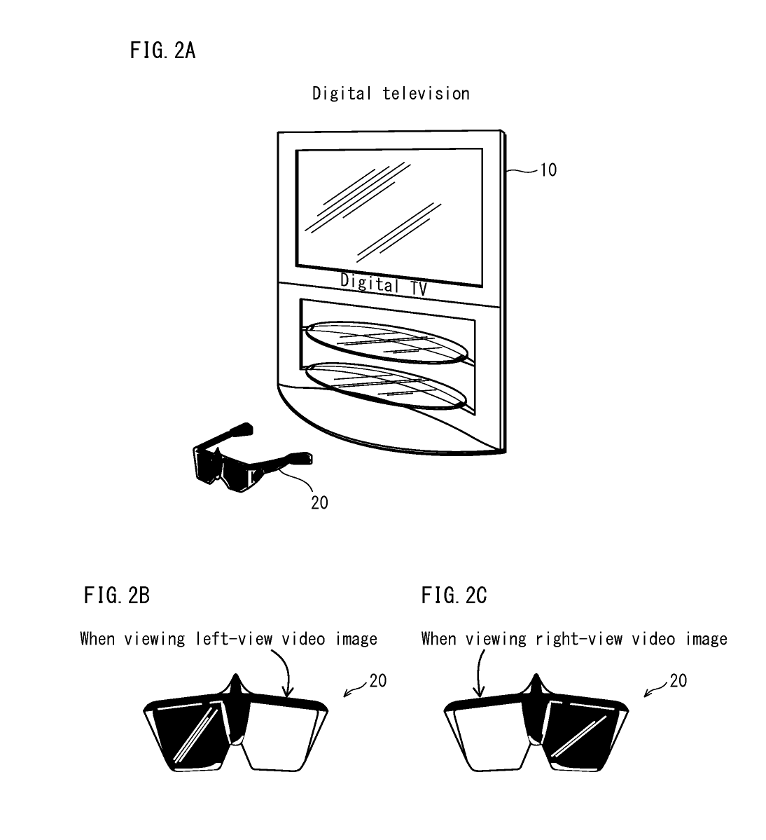

The playback device 10 is a digital television that allows for viewing of 2D video images and 3D video images, for example. FIG. 2A shows the usage of the playback device 10, which is a receiving device (digital television). As shown in FIG. 2A, a user can use the playback device (digital television) 10 in combination with 3D glasses 20.

The playback device 10 is capable of displaying 2D video images and 3D video images, and displays video images by playing back a stream included in a received broadcast wave.

Stereoscopic viewing on the playback device 10 is realized by the user wearing the 3D glasses 20. The 3D glasses 20 include liquid crystal shutters, and enable the user to view parallax images according to the alternate frame sequencing method. A parallax image is a pair of video images composed of a video image for the right eye and a video image for the left eye. The parallax image enables stereoscopic viewing by having each eye of the user view only the video image corresponding thereto. FIG. 2B shows the state of the 3D glasses 20 when a left-view video image is being displayed. At a moment when a left-view video image is displayed on the screen, the 3D glasses 20 make the liquid crystal shutter corresponding to the left eye transparent and make the liquid crystal shutter corresponding to the right eye opaque. FIG. 2C shows the state of the 3D glasses 20 when a right-view video image is being displayed. At a moment when a right-view video image is displayed on the screen, in a reversal of the above, the liquid crystal shutter corresponding to the right eye is made transparent and the liquid crystal shutter corresponding to the left eye is made opaque.

In addition, there exist playback devices which can operate using other methods than the alternate frame sequencing method described above. In contrast to the above method, in which left and right pictures are alternately output along the time axis, a left-view picture and a right-view picture may be lined up in alternate rows within one screen to be displayed, and the pictures may pass through a hog-backed lens, referred to as a lenticular lens, on the screen so that pixels constituting the left-view picture form an image for only the left eye, whereas pixels constituting the right-view picture form an image for only the right eye, thereby showing the left and right eyes a parallax picture perceived as a 3D image. Other devices, such as liquid crystal elements, may be used instead of the lenticular lens if given the same function thereas. Alternatively, a polarized light method can be used which allows for stereoscopic viewing by providing a vertically-polarizing filter for the left-view pixels and a horizontally-polarizing filter for the right-view pixels. When the viewer views the display through polarized glasses provided with a longitudinal polarization filter for the left eye and a lateral polarization filter for the right eye, a stereoscopic image is perceived.

Various other technologies for stereoscopic viewing using parallax images have been proposed, including a two-color separation method. Although the present embodiment is described through an example using the alternate frame sequencing method, no limitation is intended thereby. Other parallax viewing methods are also applicable.

This concludes the explanation of the usage of the playback device.

The following describes the structure of a typical stream transmitted by digital television broadcasts and the like.

Digital television broadcasts and the like are transmitted commonly using digital streams in the MPEG-2 transport stream (Transport Stream: TS) format. The MPEG-2 transport stream format is a standard for multiplexing and transmitting various streams including video and audio. Specifically, the standard is specified by ISO/IEC13818-1 and ITU-T Recommendations H222.0.

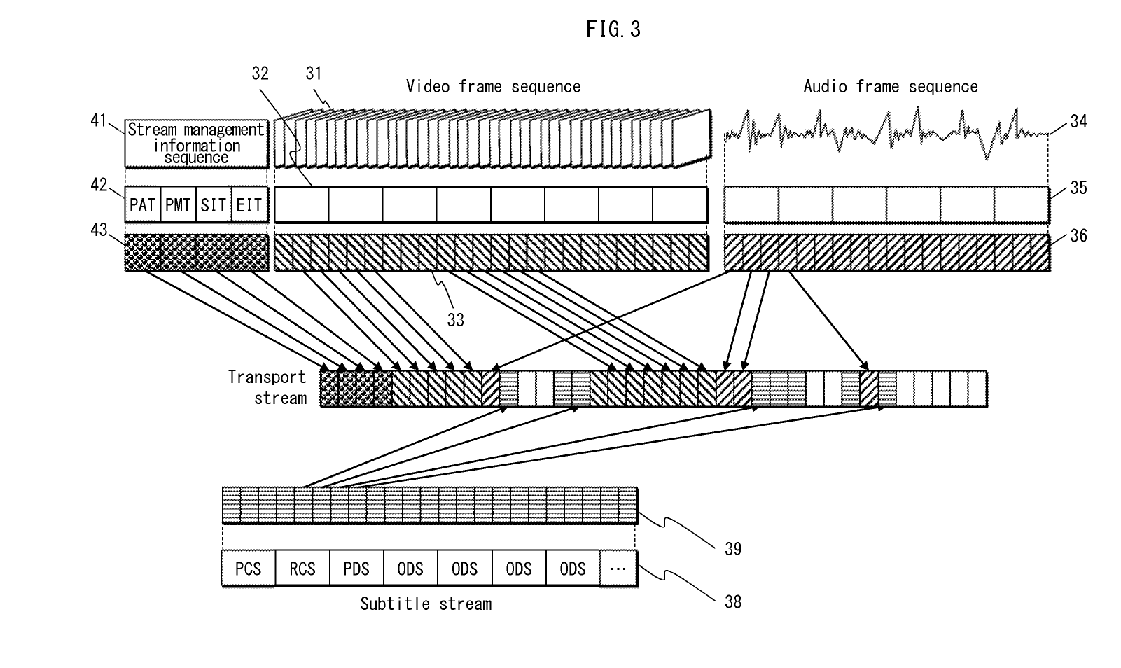

FIG. 3 shows the structure of a digital stream in the MPEG-2 transport stream format. As shown in FIG. 3, the transport stream is obtained by multiplexing a video stream, an audio stream, a subtitle stream, stream management information, and the like. The video stream stores the main video of a program. The audio stream stores main audio and sub audio. The subtitle stream stores subtitle information of the program. The video stream is encoded with use of a method such as MPEG-2 or MPEG-4 AVC. The audio stream is compression-encoded with use of a method such as Dolby AC-3, MPEG-2 AAC, MPEG-4AAC, or HE-AAC.

As shown in FIG. 3, the video stream is obtained by converting a video frame sequence 31 into a PES packet sequence 32, and converting the PES packet sequence 32 into a TS packet sequence 33.

The audio stream is obtained by converting an audio signal into an audio frame sequence 34 via quantization and sampling, converting the audio frame sequence 34 into a PES packet sequence 35, and converting the PES packet sequence 35 into a TS packet sequence 36, as shown in FIG. 3.

The subtitle stream is obtained by converting a functional segment sequence 38 into a TS packet sequence 39, as shown in FIG. 3. The functional segment sequence 38 includes multiple types of functional segments, such as a Page Composition Segment (PCS), a Region Composition Segment (RCS), a Pallet Define Segment (PDS), and an Object Define Segment (ODS).

The stream management information is stored in a system packet called PSI (Program Specification Information), and is for managing the video stream, the audio stream, and the subtitle stream which are multiplexed in the transport stream as a single broadcast program. As shown in FIG. 3, the stream management information includes a PAT (Program Association Table), a PMT (Program Map Table), an EIT (Event Information Table), and an SIT (Service Information Table). The PAT indicates the PID of the PMT used within the transport stream, and is registered by the PID arrangement of the PAT itself. The PMT includes: the PIDs of the respective streams included in the transport stream, such as the video stream, the audio stream, and the subtitle stream; attribute information of each of the streams corresponding to the PIDs; and various descriptors pertaining to the transport stream. One example of such descriptors is copy control information indicating whether copying of the AV stream is permitted. The SIT is information defined according to the standard of each of the broadcast waves, and utilizes a user-definable area in the MPEG-2TS format. The EIT includes information relating to the title of the program, the broadcast date and time, the content of the program, or the like. For more information concerning the specific format of the aforementioned types of information, refer to the reference material published for ARIB (Association of Radio Industries and Businesses), which is stored at http:www.arib.or.jp/english/html/overview/doc/4-TR-B14v44-2p3.pdf.

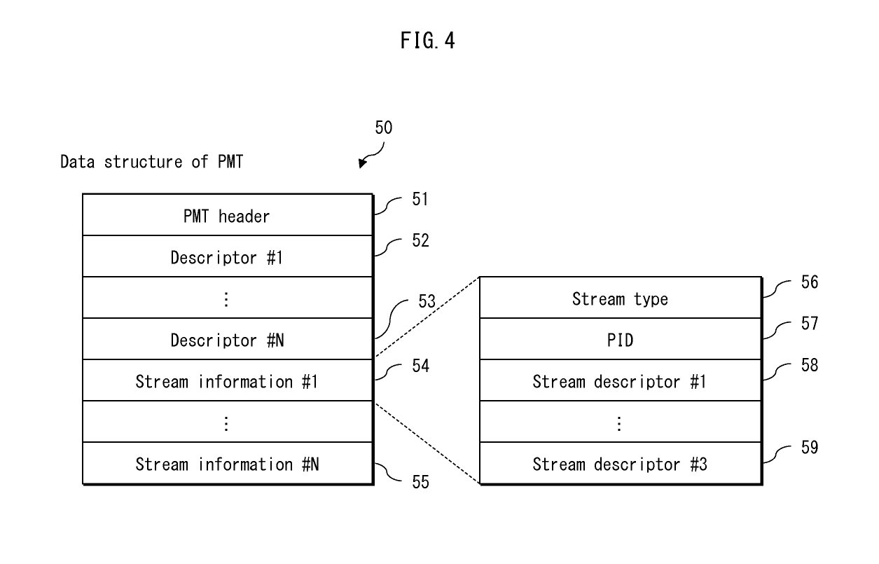

FIG. 4 shows the data structure of the PMT in detail. A PMT header 51 is arranged at the top of a PMT 50, and indicates the length of data included in the PMT 50, etc. The PMT header 51 is followed by descriptors 52, . . . , 53 that relate to the transport stream. Each of the descriptors 52, . . . , 53 includes the aforementioned copy control information. The descriptors 52, . . . , 53 are followed by multiple pieces of stream information, i.e., stream information 54, . . . , 55, that relate to the respective streams included in the transport stream. Each piece of the stream information includes: a stream type 56 for identifying the compression codec, etc., of a stream; a PID 57 of the stream; and stream descriptors 58, . . . , 59 including stream attribute information (e.g., frame rate, aspect ratio, etc.).

This concludes the description of the transport stream and the stream management information included therein. The following describes a video stream in detail.

A video stream generated in the encoding method described in Embodiment 1 is compression-encoded in a video compression encoding method such as MPEG-2, MPEG-4 AVC, or SMPTE (Society of Motion Picture and Television Engineers) VC1. Under such a compression encoding method, compression of data is performed with use of spatial and temporal redundancies in moving images. One example of a method using a temporal redundancy is the inter-picture predictive encoding. According to the inter-picture predictive encoding, a given picture is encoded with use of a reference picture having an earlier or later presentation time than the given picture. Specifically, the following steps are performed to compress data: detecting the amount of motion from the reference picture; performing motion compensation on the reference picture; and removing the spatial redundancy from a difference value between the motion-compensated picture and the picture to be encoded.

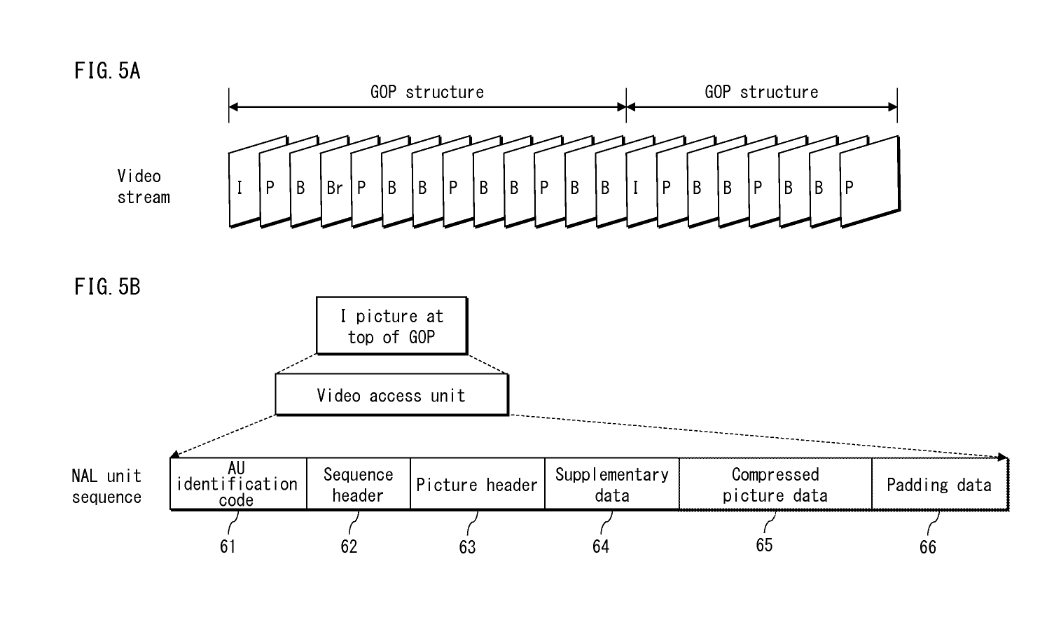

The video streams encoded with use of such encoding methods as described above are similar in having a GOP (Group of Picture) structure as shown in FIG. 5A. A video stream is composed of GOPs. Using GOPs as the primary units of encoding allows for moving images to be edited or randomly accessed. A GOP is composed of one or more video access units. FIG. 5A shows an example of GOPs.

As shown in FIG. 5A, a GOP is composed of multiple types of picture data, such as an I-picture, a P-picture, a B-picture, and a Br-picture.

Among such picture data composing the GOP, a picture to which intra-picture predictive encoding is applied by using only the encoding-target picture itself, without using any reference pictures, is referred to as an Intra picture (I-picture). Note that a picture is defined as a unit of encoding that encompasses both a frame and a field. Also, a picture to which inter-picture predictive encoding is applied with reference to one previously-processed picture is referred to as a P-picture, a picture to which inter-picture predictive encoding is applied with reference to two previously-processed pictures at once is referred to as a B-picture, and a B-picture referenced by other pictures is referred to as a Br-picture. Also, in the present embodiment, the frames in a frame structure and the fields in a field structure are referred to as “video access units”.

A video access unit is a unit of storage of encoded picture data, storing one frame in the case of a frame structure, and one field in the case of a field structure. A GOP begins with an I-picture. Here, for the sake of facilitating the following description, presumption is made that the compression-encoding method applied to video streams is the MPEG-4 AVC, unless otherwise stated. Description on a case where the compression-encoding method applied is the MPEG-2 is omitted hereinafter.

FIG. 5B shows the internal structure of a video access unit that corresponds to an I-picture, which is arranged at the top of a GOP. The video access unit corresponding to the top of the GOP is composed of multiple network abstraction layer (NAL) units. As shown in FIG. 5A, the video access unit corresponding to the top of the GOP is composed of NAL units such as: an AU (Access Unit) identification code 61; a sequence header 62; a picture header 63; supplementary data 64; compressed picture data 65; and padding data 66.

The AU identification code 61 is a start code indicating the beginning of the corresponding video access unit. The sequence header 62 stores information that is shared among a plurality of video access units constituting a playback sequence.

Such information includes: resolution, a frame rate, an aspect ratio, a bit rate and the like. The picture header 63 stores information such as the encoding method of the entire picture. The supplementary data 64 is additional data that is not required for decoding of the compressed data, and includes information such as closed-captioning text information that can be displayed on a television in sync with the video, information about the GOP structure, and so on. The compressed picture data 65 includes data of a picture that has been compression-encoded. The padding data 66 includes meaningless data for maintaining the format. For example, the padding data is used as stuffing data for maintaining a fixed bit rate.

The internal structure of each of the AU identification code 61, the sequence header 62, the picture header 63, the supplementary data 64, the compressed picture data 65, and the padding data 66 varies according to the video encoding method.

For example, under MPEG-4 AVC, the AU identification code 61 corresponds to an AU Delimiter (Access Unit Delimiter), the sequence header 62 corresponds to an SPS (Sequence Parameter Set), the picture header 63 corresponds to a PPS (Picture Parameter Set), the supplementary data 64 corresponds to SEI (Supplemental Enhancement Information), the compressed picture data 65 corresponds to several slices of data, and the padding data 66 corresponds to Filler Data.

Under MPEG-2, the sequence header 62 corresponds to any of “sequence_Header”, “sequence_extension”, and “group_of_pictures_header”, the picture header 63 corresponds to either “picture_header” or “picture_coding_extension”, the supplementary data 64 corresponds to user_data, and the compressed picture data 65 corresponds to several slices of data. Although the AU identification code 61 is not present in the case of MPEG-2, breaks between video access units can be determined with use of the start code of each header. Each stream stored in the transport stream is identified by a stream ID called a PID. A decoder can extract a decoding-target stream by extracting packets with the corresponding PID. The correlation between the PIDs and the streams is stored in descriptors contained in a PMT packet, description on which is provided in the following.

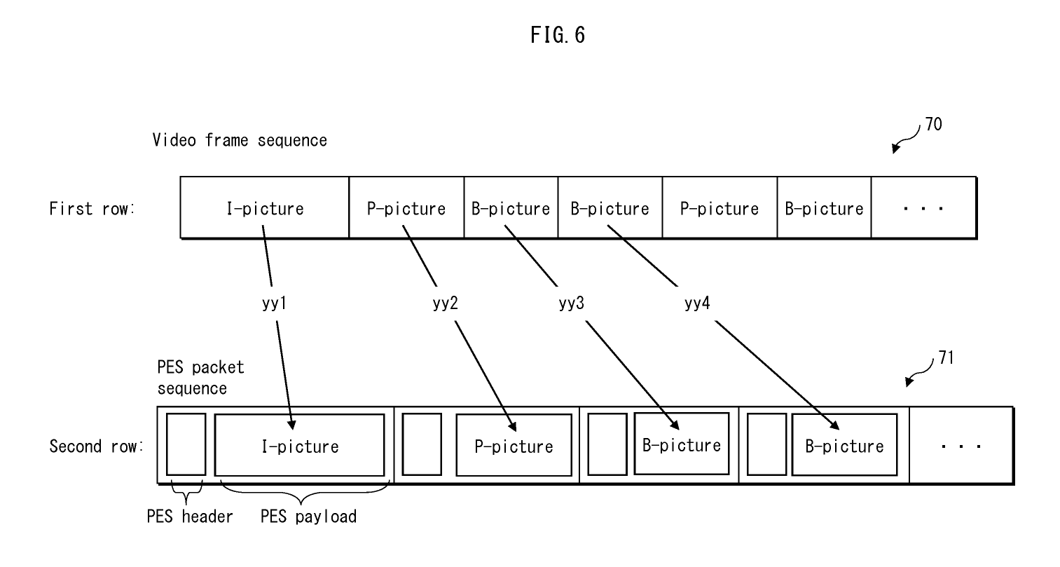

Each piece of picture data is converted as shown in FIG. 6, and is stored in the payload of a PES (Packetized Elementary Stream) packet. FIG. 6 shows a process in which each piece of picture data is converted into a PES packet.

The first row in FIG. 6 shows a video frame sequence 70 of the video stream. The second row shows a PES packet sequence 71. As shown by the arrows yy1, yy2, yy3, and yy4 in FIG. 6, the I-picture, B-pictures, and P-pictures, which are video presentation units in the video stream, are separated picture by picture and stored in the payload of a corresponding PES packet. Each PES packet has a PES header. The PES header stores a PTS (Presentation Time-Stamp), which indicates the presentation time of the corresponding picture, and a DTS (Decoding Time-Stamp), which is the decoding time of the corresponding picture.

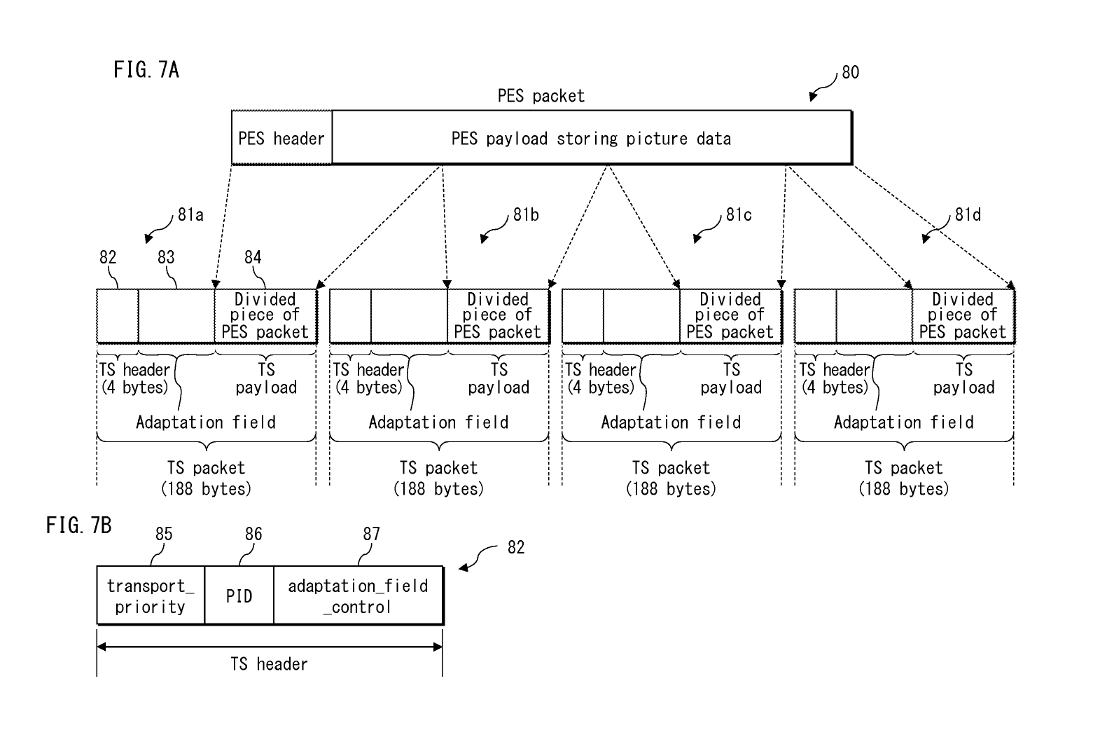

A PES packet obtained by converting a picture is then divided into multiple pieces. Each of the pieces of the PES packet is then stored in the payload of a corresponding TS packet. FIG. 7A shows the data structure of TS packets 81a, 81b, 81c, and 81d that constitute the transport stream. The TS packets 81a, 81b, 81c, and 81d have the same data structure. Accordingly, the following describes the data structure of the TS packet 81a. The TS packet 81a has a fixed length of 188 bytes and is composed of a 4-byte TS header 82, an adaptation field 83, and a TS payload 84. As shown in FIG. 7B, the TS header 82 includes transport_priority 85, PID 86, and adaptation_field_control 87.

The PID 86 is an ID identifying a stream multiplexed in the transport stream, as described above.

The transport_priority 85 is information for identifying the type of packet among TS packets with the same PID.

Here, it is to be noted that a TS packet need not be provided with all such information as described above. That is, there exist a case where only one of the adaptation field and the TS payload exists, and a case where both exist. The adaptation_field_control 87 indicates whether both the adaptation field 83 and the TS payload 84 exist in the TS packet. When the adaptation_field_control 87 indicates the value “1”, only the TS payload 84 exists. When the adaptation_field_control 87 indicates the value “2”, only the adaptation field 83 exists. When the adaptation_field_control 87 indicates the value “3”, both the adaptation field 83 and the TS payload 84 exist.

The adaptation field 83 is an area for storing PCR and similar information, as well as being an area for stuffing data used to adjust the TS packet to a fixed length of 188 bytes. The TS payload 84 stores a divided piece of the PES packet.

As described above, each piece of picture data is converted and incorporated into the transport stream by PES packetization and TS packetization. Further, it can be seen that the parameters composing a piece of picture data are converted into NAL units.

In addition to the TS packets of the video, audio, subtitle, and other streams, the transport stream includes the TS packets of a PAT, a PMT, a PCR (Program Clock Reference), and the like. These packets are referred to as PSI which has been described above. The PID of the TS packet including the PAT is 0. The PCR has STC (System Time Clock) information corresponding to the timing at which the PCR packet is transferred to the decoder. This information enables synchronization between the time at which the TS packet arrives at the decoder and the STC, which serves as the time axis for the PTS and DTS.

This concludes the description on the structure of a typical stream transmitted by digital television broadcasts and the like.

The following describes a typical video format for realizing parallax images used for stereoscopic viewing.

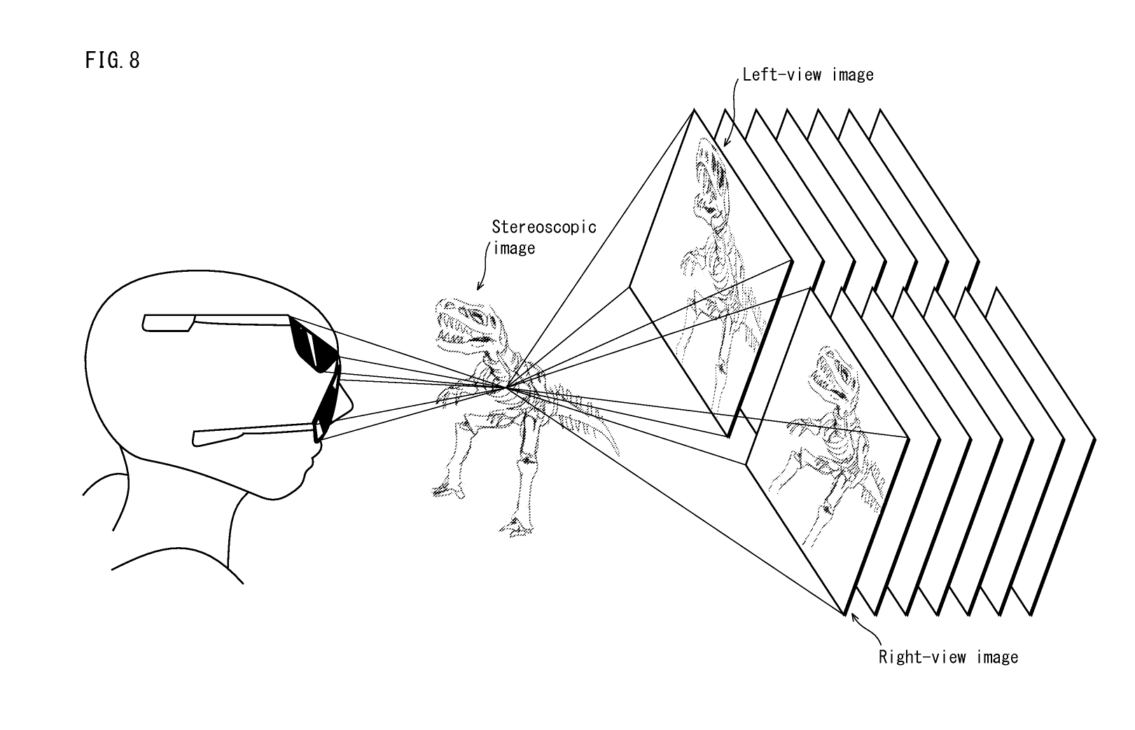

A stereoscopic viewing method using parallax images involves preparing respective pictures for the right eye and the left eye such that each eye sees only pictures corresponding thereto in order to achieve the stereoscopic effect. FIG. 8 shows the head of a user on the left-hand side, and, on the right-hand side, an example of a dinosaur skeleton as viewed by the left eye as well as by the right eye. By repeatedly alternating the transparency and opacity for the left and right eyes, the user's brain is made to combine the views of the respective eyes from afterimage effects, resulting in the perception that a stereoscopic object exists along an imaginary line extending from the middle of the face.

In the context of parallax images, images viewed by the left eye are called left-view images (L-images) and images viewed by the right eye are called right-view images (R-images). Furthermore, moving images in which each picture is an L-image is called the left-view video and moving images in which each picture is an R-image is called the right-view video.

3D video methods for combining and compression-encoding the left-view video and right-view video include a frame alternating method and a multiview encoding method.

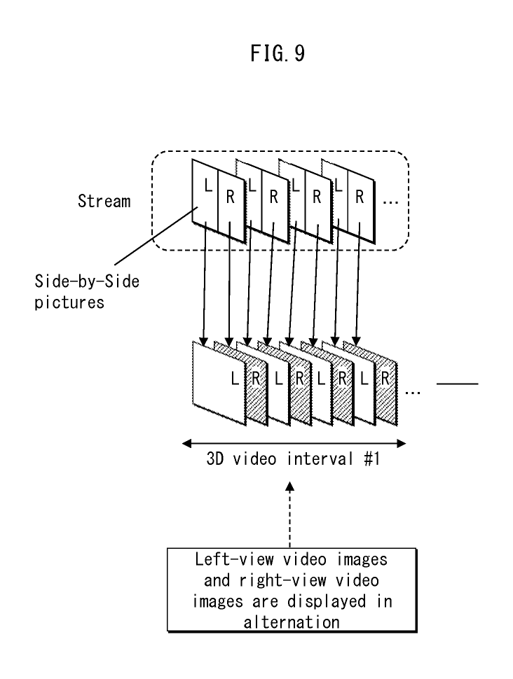

The frame-compatible method is a commonly-used motion picture compression-encoding method that involves skipping or shrinking each of the pictures corresponding to the left-view video and the right-view video so as to combine the pictures into one. An example of this is the Side-by-Side method as shown in FIG. 9. The Side-by-Side method horizontally compresses each of the pictures corresponding to the left-view video and the right-view video by a factor of ½ and laterally aligns the compressed pictures side by side to form a single picture. The moving images made up of the pictures thus formed are encoded into a stream according to the commonly-used motion picture compression-encoding method. During playback, the stream is decoded into moving images according to the commonly-used motion picture compression-encoding method. Further, each picture within the decoded moving images is divided into left and right images, which are horizontally expanded by a factor of two to yield pictures corresponding to the left-view video and the right-view video. The pictures thus obtained of the left-view video (L-images) and the right-view video (R-images) are displayed in alternation so as to obtain a stereoscopic image as shown in FIG. 8. Aside from the Side-by-Side method, the frame alternating method can be achieved using a top-and-bottom method, in which left and right images are aligned vertically, or a line alternative method, in which the lines within each picture are interleaved lines from the left and right images, and the like.

Next, the multiview encoding method is described. One example of the multiview encoding method is MPEG-4 MVC (Multiview Video Coding), which is a revised MPEG-4 AVC/H.264 standard. With this method, 3D video images are compress-encoded with high efficiency. In July 2008, the Joint Video Team (JVT), which is a cooperative project between the ISO/IEC MPEG and the ITU-T VCEG, completed formulation of the revised MPEG-4 AVC/H.264 standard called Multiview Video Coding (MVC).

According to the multiview encoding method, a left-view video stream and a right-view video stream are used. The left-view video stream and right-view video stream are obtained by digitalizing and compression-encoding the left-view video and the right-view video.

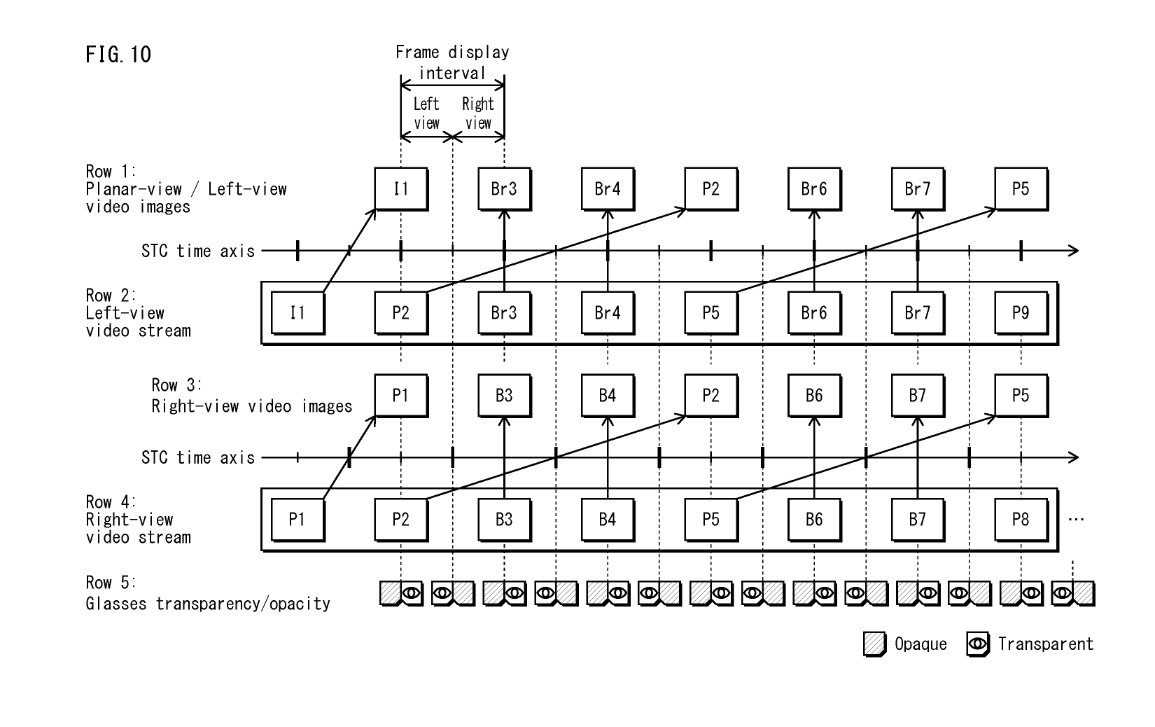

FIG. 10 shows an example of the internal structure of a left-view video stream and a right-view video stream used in the multiview encoding method for realizing stereoscopic viewing.

The second row of FIG. 10 shows the internal structure of the left-view stream. The left-view stream includes picture data I1, P2, Br3, Br4, P5, Br6, Br7, and P9. Each of these pieces of picture data is decoded in accordance with the corresponding DTS. The first row shows the left-view video images. The left-view video images are played back by playing back the decoded picture data I1, P2, Br3, Br4, P5, Br6, Br7, and P9 in the order of I1, Br3, Br4, P2, Br6, Br7, and P5 and in accordance with the PTSs. In FIG. 10, a picture to which intra-picture predictive encoding is applied without the use of a reference picture is called an I-picture. Note that a picture is defined as a unit of encoding that encompasses both a frame and a field. A picture on which the inter-picture predictive encoding is performed with reference to another picture that has already been processed is called a P-picture. A picture on which the inter-picture predictive encoding is performed by simultaneously referring to two other pictures that have already been processed is called a B-picture. A B-picture that is referred to by another picture is called a Br-picture.

The fourth row in FIG. 10 shows the internal structure of the right-view video stream. The right-view video stream includes picture data P1, P2, B3, B4, P5, B6, B7, and P8. Each of these pieces of picture data is decoded in accordance with the corresponding DTS. The third row shows the right-view video images. The right-view video images are played back by playing back the decoded picture data P1, P2, B3, B4, P5, B6, B7, and P8 in the order of P1, B3, B4, P2, B6, B7, and P5 in accordance with the PTSs. Note that stereoscopic playback in the alternate frame sequencing method displays one of the pair of a left-view video image and a right-view video image that share the same PTS, with a delay equal to half the PTS interval (hereinafter “3D display delay”) following the display of the other one of the pair.

The fifth row shows how the state of the 3D glasses 20 changes. As shown in the fifth row, the right-eye shutter is closed when the left-view video images are viewed, and the left-eye shutter is closed when the right-view video images are viewed.

In addition to inter-picture predictive encoding that makes use of correlations between pictures along the time axis, the left-view stream and the right-view stream are also compressed using inter-picture predictive encoding that makes use of correlations between the different perspectives. The pictures of the right-view stream are compressed with reference to the pictures of the left-view stream with the same presentation time.

For example, the leading P-picture of the right-view video stream refers to an I-picture of the left-view video stream, the B-pictures of the right-view stream refer to Br-pictures of the left-view stream, and the second P-picture of the right-view stream refers to a P-picture of the left-view stream.

Furthermore, among the compression-encoded left-view video stream and the compression-encoded right-view video stream, a video stream that can be decoded independently is called a “base-view video stream”. Also, among the compression-encoded left-view video stream and the compression-encoded right-view video stream, a video stream that can only be decoded after the base-view video stream has been decoded is called a “dependent-view video stream”. In detail, pieces of picture data constituting the dependent-view video stream are compression-encoded according to inter-frame correlations with pieces of the picture data constituting the base-view video stream. Also, the pair of the base-view video stream and the dependent-view video stream is called “multiview video stream”. The base view video stream and the dependent-view video stream may be stored and transferred as separate streams, or may be multiplexed into a single stream such as an MPEG2-TS stream.

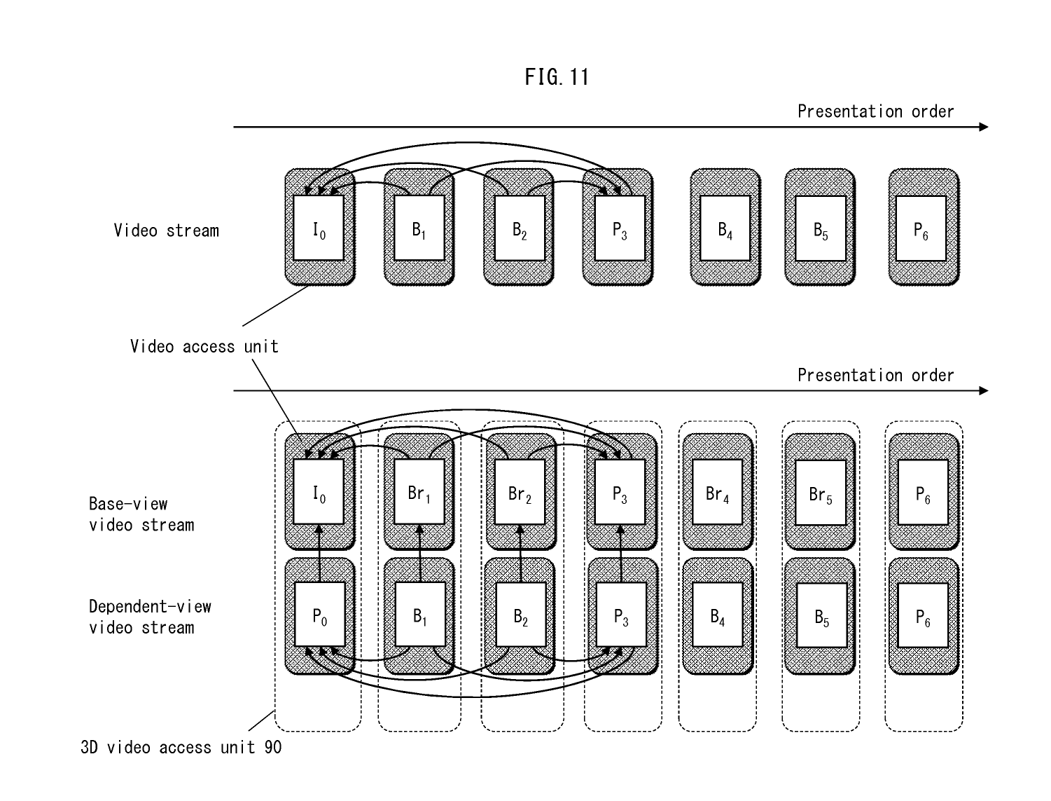

The following describes the relationship between access units in the base-view video stream and the dependent-view video stream. FIG. 11 shows the structure of the video access units for pictures in the base-view video stream and in the right-view video stream. As described above, the base-view video stream is configured such that one picture corresponds to one video access unit, as shown in the upper tier of FIG. 11. Similarly, as shown in the lower tier of FIG. 11, the dependent-view video stream is configured such that one picture corresponds to one video access unit. The data structure differs, however, from that of the video access unit in the base-view video stream. As shown in the lower tier of FIG. 11, a video access unit in the base view video stream and a video access unit in the dependent-view video stream that have the same presentation time constitute a 3D video access unit 90. A video decoder, which is described later, decodes and displays one 3D video access unit at a time. According to the video codec of MPEG-4 MVC, each picture in a single view (video access unit in the present embodiment) is defined as a “view component”, and a group of pictures in a multiview (3D video access unit in the present embodiment) at the same time point is defined as an “access unit”. In the present embodiment, however, description is provided with the definitions used in FIG. 11.

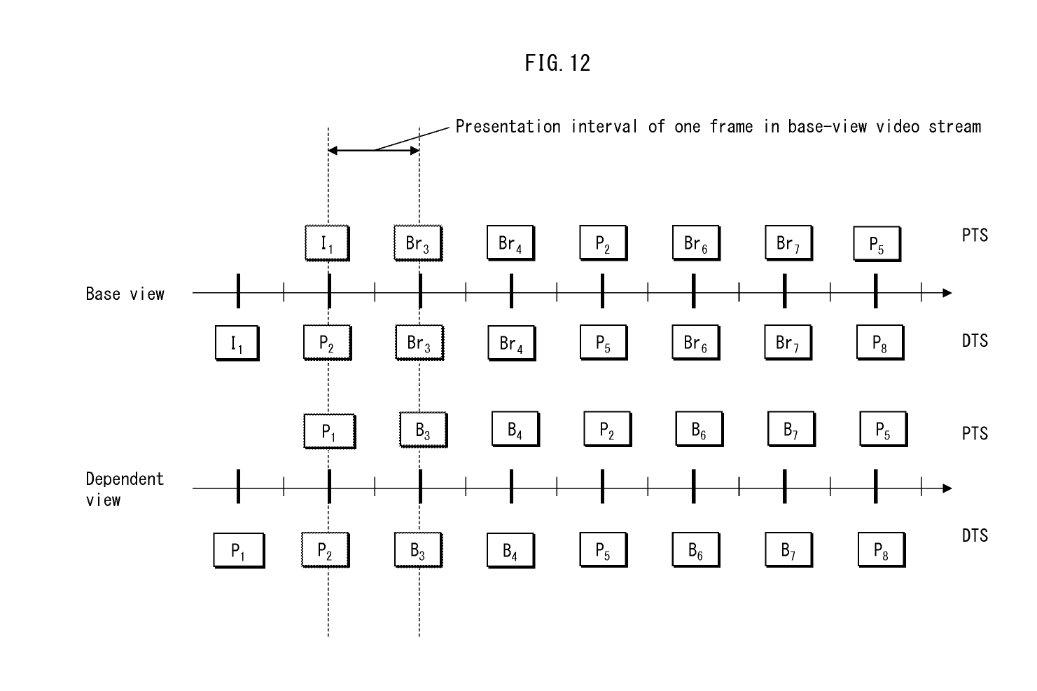

FIG. 12 shows an example of the relationship between the presentation time (PTS) and the decoding time (DTS) allocated to each video access unit in the base view video stream and the dependent-view video stream in the AV stream.

A picture in the base-view video stream and a picture in the dependent-view video stream that each store a video image for a parallax image at the same time is set to have the same DTS and PTS. This is realized by setting such that base-view pictures and dependent-view pictures that are in the reference relationship during the inter-picture predictive encoding have the same decoding/presentation order. With this structure, the video decoder that decodes pictures in the base-view video stream and pictures in the dependent-view video stream can decode and display one 3D video access unit at a time.

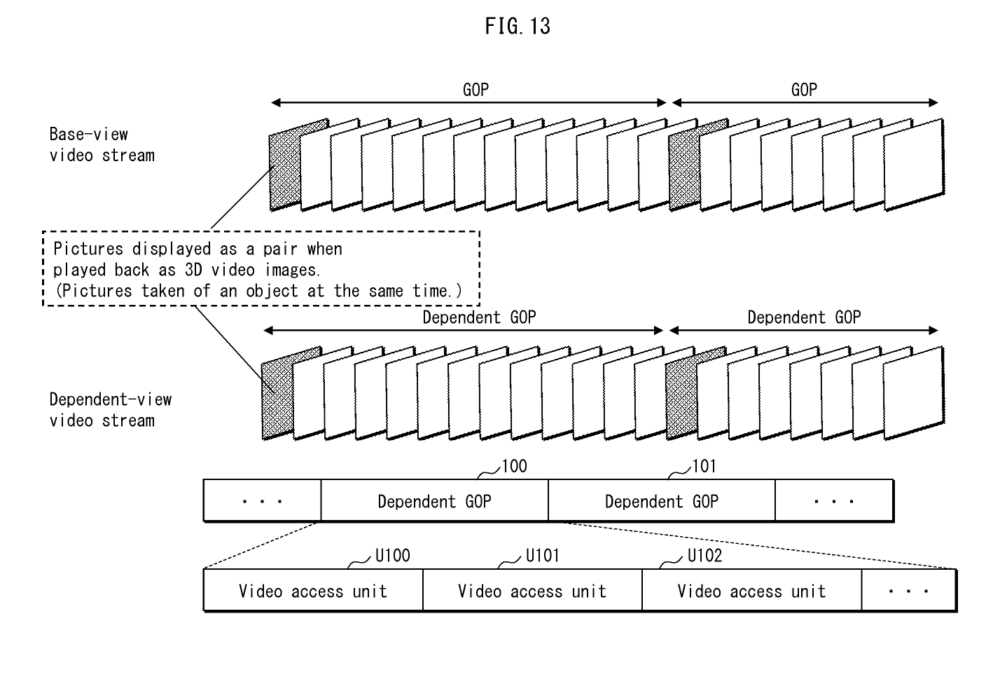

FIG. 13 shows the GOP structure of the base-view video stream and the dependent-view video stream. The GOP structure of the base-view video stream is the same as the structure of a typical video stream and is composed of a plurality of video access units. The dependent-view video stream is composed of dependent GOPs 100, 101, . . . , similarly to a typical video stream. Each of the dependent GOPs is composed of video access units U100, U101, U102, . . . . When playing back 3D video images, the leading picture in each dependent GOP is displayed as a pair with the I-picture at the top of each GOP in the base-view video stream, and has the same PTS as the I-picture at the top of each GOP of the base-view video stream.

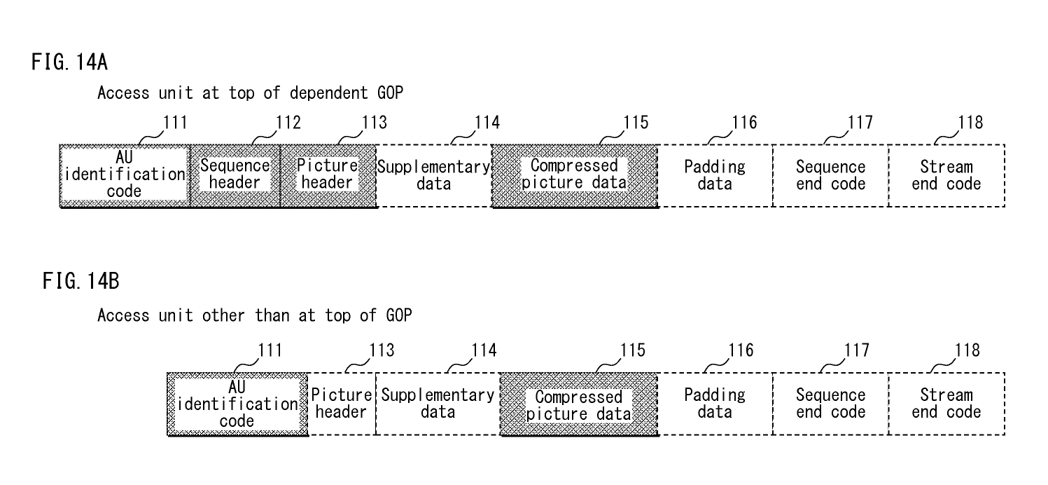

FIGS. 14A and 14B each show the structure of a video access unit in a dependent GOP. As shown in FIGS. 14A and 14B, each of the video access units in the dependent GOP includes an AU identification code 111, a picture header 113, supplementary data I14, compressed picture data I15, padding data I16, a sequence end code 117, and a stream end code 118. The video access unit at the top of the dependent GOP further includes a sequence header 112. Similarly to the AU identification code 61 shown in FIG. 4, the AU identification code 111 is a start code indicating the beginning of the video access unit. The sequence header 112, the picture header 113, the supplementary data I14, the compressed picture data I15, the padding data I16 are respectively the same as the sequence header 62, the picture header 63, the supplementary data 64, the compressed picture data 65, and the padding data 66 in FIG. 4. The description of these pieces of data is therefore omitted. The sequence end code 117 is data indicating the end of the corresponding playback sequence. The stream end code 118 is data indicating the end of the corresponding bit stream.

Regarding the video access unit at the top of the dependent GOP as shown in FIG. 14A, the compressed picture data I15 always stores data for a picture displayed at the same time as the I-picture at the top of a GOP in the base-view video stream. Also, each of the AU identification code 111, the sequence header 112, and the picture header 113 always stores data. The supplementary data I14, the padding data 116, the sequence end code 117, and the stream end code 118 may or may not store data. The frame rate, the resolution, and the aspect ratio in the sequence header 112 have the same values as the frame rate, the resolution, and the aspect ratio in the sequence header included in the video access unit at the top of the GOP in the corresponding base-view video stream. Regarding a video access unit other than at the top of the dependent GOP as shown in FIG. 14B, each of the AU identification code 111 and the compressed picture data I15 always stores data. The picture header 113, the supplementary data I14, the padding data I16, the sequence end code 117, and the stream end code 118 may or may not store data.

This concludes the description provided on a typical video format for realizing parallax images used for stereoscopic viewing.

2.2 Structure

2.2.1 Video Transmission and Reception System 1000

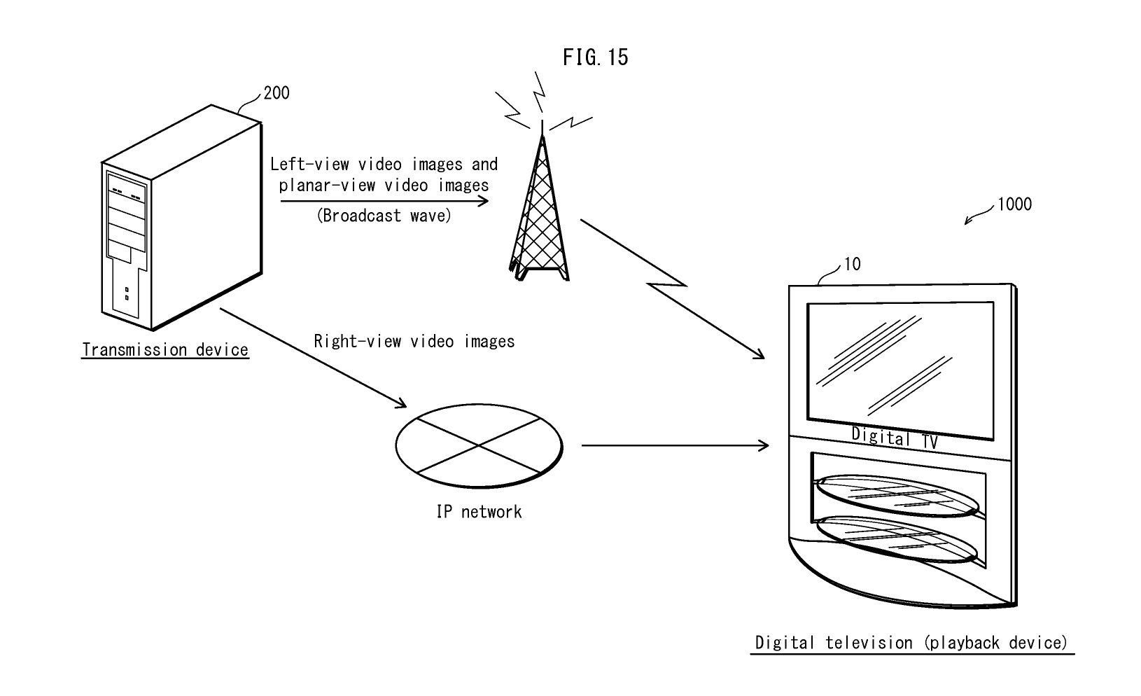

As shown in FIG. 15, a video transmission and reception system 1000 includes a digital television (playback device) 10 and a transmission device 200.

The transmission device 200 transmits a 3D program including 3D video images and 2D video images. The 3D video images in the 3D program constitute the main part of the program, and are realized by left-view video images and right-view video images. For example, if the 3D program is a drama, the 3D video images are the video images of the drama. The 2D video images in the 3D program constitute parts other than the main part of the program, and are not used for stereoscopic viewing (3D playback). For example, the 2D video images constitute a commercial message. Hereinafter, the 2D video images not used for stereoscopic viewing (3D playback) are referred to as planar-view video images.

The transmission device 200 generates a transport stream by encoding the left-view video images for realizing the 3D video images and generates a transport stream by encoding the planar-view video images. Then, the transmission device 200 multiplexes these transport streams to generate a multiplexed stream and transmits the multiplexed stream as a broadcast wave to the playback device 10.

Also, the transmission device 200 generates a transport stream by encoding the right-view video images for realizing the 3D video images, and transmits the transport stream to the playback device 10 via an IP network such as the Internet.

The playback device 10 receives the encoded left-view video images and the encoded planar-view video images as a broadcast wave, and decodes these encoded video images. Furthermore, the playback device 10 receives the encoded right-view video images via the IP network, and decodes the right-view video images. The playback device 10 alternately plays back the decoded left-view video images and the decoded right-view video images so that the viewer perceives these video images as 3D video images. Also, the playback device 10 plays back the decoded planar-view video images as 2D video images in a usual manner.

The following describes the structure of each device in detail.

2.2.2 Transmission Device 200

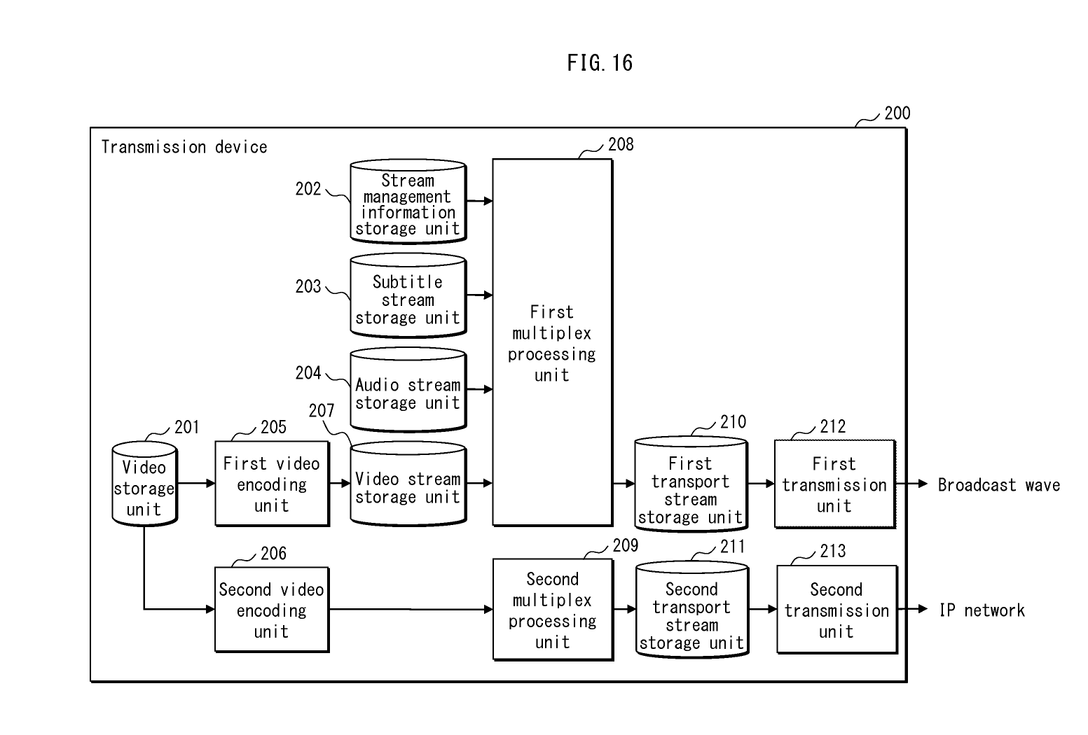

As shown in FIG. 16, the transmission device 200 includes a video storage unit 201, a stream management information storage unit 202, a subtitle stream storage unit 203, an audio stream storage unit 204, a first video encoding unit 205, a second video encoding unit 206, a video stream storage unit 207, a first multiplex processing unit 208, a second multiplex processing unit 209, a first transport stream storage unit 210, a second transport stream storage unit 211, a first transmission unit 212, and a second transmission unit 213.

(1) Video Storage Unit 201

The video storage unit 201 is a storage area that stores a plurality of video images (i.e., left-view video images, right-view video images, and planar-view video images) constituting a 3D program to be broadcast (to be transmitted).

Each video image stored in the video storage unit 201 is associated with a video identifier indicating whether the video image is a 3D video image or a planar-view video image.

In the video storage unit 201, the video images are divided into a left-view group and a right-view group. The left-view group consists of left-view video images and planar-view video images. The right-view group consists of right-view video images and planar-view video images. In each of the groups stored in the video storage unit 201, the video images are arranged in the playback order. At this point, the planar-view video images belong to both of the groups.

(2) Stream Management Information Storage Unit 202

The stream management information storage unit 202 is a storage area that stores SI (Service Information)/PSI (Program Specific Information) which is transmitted as a broadcast wave along with the left-view video images and the planar-view video images.

The SI/PSI indicates a broadcast station, details of a channel (service), details of a program, and the like. The SI/PSI is well-known, and detailed description thereof is omitted here.

(3) Subtitle Stream Storage Unit 203

The subtitle stream storage unit 203 is a storage area that stores subtitle data relating to subtitles that are to be superimposed on video images and played back.

The subtitle data in the subtitle stream storage unit 203 has been encoded with use of a method such as MPEG-1 or MPEG-2.

(4) Audio Stream Storage Unit 204

The audio stream storage unit 204 is a storage area that stores audio data. This audio data has been compression-encoded with use of a method such as linear PCM.

(5) First Video Encoding Unit 205

The first video encoding unit 205 encodes the left-view video images and the planar-view video images stored in the video storage unit 201. This encoding is performed with use of the MPEG-2 Video standard.

Specifically, the first video encoding unit 205 reads, from the video storage unit 201, the left-view video images and the planar-view video images in the left-view group according to a predetermined encoding order.

The first video encoding unit 205 determines, for each of the read video images, whether the video image is a 3D video image (a left-view video image in this case) or a planar-view video image, with use of the video identifier associated with the video image.

The first video encoding unit 205 compression-encodes the read video images to generate video access units on a per-video image (per-picture) basis. Also, according to the results of the determination using the video identifiers, the first video encoding unit 205 stores a 2D video flag into the supplementary data of the video image in each video access unit. The 2D video flag indicates whether the video image is a planar-view video image or not.

The first video encoding unit 205 stores the left-view video images and the planar-view video images thus compression-encoded into the video stream storage unit 207.

Hereinafter, the video stream including both the left-view video images and the planar-view video images compression-encoded by the first video encoding unit 205 is referred to as a left-view video stream. The left-view video stream corresponds to an elementary stream (ES).

Encoding in the MPEG-2 Video standard is a well-known technology. As such, description thereof is omitted here.

(6) Second Video Encoding Unit 206

The second video encoding unit 206 encodes the right-view video images stored in the video storage unit 201, with use of the MPEG-2 Video standard.

Specifically, the second video encoding unit 206 reads, from the video storage unit 201, the right-view video images and planar-view video images in the right-view group according to a predetermined encoding order.

The second video encoding unit 206 determines, for each of the read video images, whether the video image is a 3D video image (a right-view video image in this case) or a planar-view video image, with use of the video identifier associated with the read video image.

When it is determined that the read video image is a 3D video image, the second video encoding unit 206 compression-encodes the video image (right-view video image). When it is determined that the read video image is a planar-view video image, the second video encoding unit 206 compression-encodes a black screen instead of compression-encoding the video image (planar-view video image). Alternatively, the second video encoding unit 206 may compression-encode the video image (planar-view video image) at a lower bit rate than the bit rate used to compression-encode a 3D video image (right-view video image in this case).

Hereinafter, the video stream including both the right-view video images and the black screens compression-encoded by the second video encoding unit 206 is referred to as a right-view video stream. The right-view video stream corresponds to an ES.

(7) Video Stream Storage Unit 207

The video stream storage unit 207 is a storage area that stores the left-view video images and the planar-view video images compression-encoded by the first video encoding unit 205.

(8) First Multiplex Processing Unit 208

The first multiplex processing unit 208 packetizes, as necessary, the pieces of information (i.e., SI/PSI, subtitle data, compression-encoded audio data, and compression-encoded video images) stored in the stream management information storage unit 202, the subtitle stream storage unit 203, the audio stream storage unit 204, and the video stream storage unit 207. Then, the first multiplex processing unit 208 multiplexes the packetized pieces of information to generate at least one transport stream (TS) in an MPEG 2-TS format, and stores the transport stream into the first transport stream storage unit 210.

Hereinafter, the TS generated by the first multiplex processing unit 208 is referred to as a left-view TS.

(9) Second Multiplex Processing Unit 209

The second multiplex processing unit 209 packetizes, as necessary, the video images compression-encoded by the second video encoding unit 206. Then, the second multiplex processing unit 209 multiplexes the packetized video images to generate at least one TS in the MPEG 2-TS format, and stores the TS into the second transport stream storage unit 211.

Hereinafter, the TS generated by the second multiplex processing unit 209 is referred to as a right-view TS.

(10) First Transport Stream Storage Unit 210

The first transport stream storage unit 210 is a storage area that stores the left-view TS generated by the first multiplex processing unit 208.

(11) Second Transport Stream Storage Unit 211

The second transport stream storage unit 211 is a storage area that stores the right-view TS generated by the second multiplex processing unit 209.

(12) First Transmission Unit 212

The first transmission unit 212 transmits the left-view TS stored in the first transport stream storage unit 210 as a broadcast wave.

(13) Second Transmission Unit 213

The second transmission unit 213 transmits, to an external source, the right-view TS stored in the second transport stream storage unit 211 via the IP network.

2.2.3 Playback Device 10

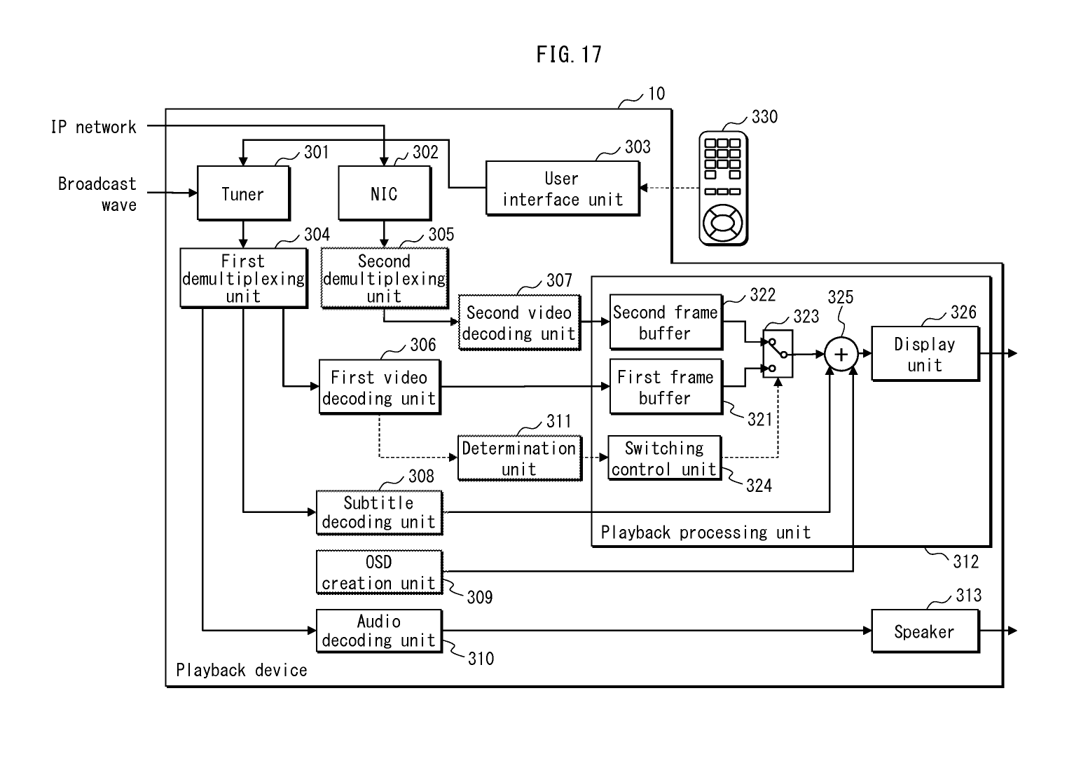

As shown in FIG. 17, the playback device 10 includes a tuner 301, a network interface card (NIC) 302, a user interface unit 303, a first demultiplexing unit 304, a second demultiplexing unit 305, a first video decoding unit 306, a second video decoding unit 307, a subtitle decoding unit 308, an on-screen display (OSD) creation unit 309, an audio decoding unit 310, a determination unit 311, a playback processing unit 312, and a speaker 313.

(1) Tuner 301

The tuner 301 receives a digital broadcast wave (left-view TS in the present embodiment), and demodulates a signal in the digital broadcast wave.

The tuner 301 outputs the demodulated left-view TS to the first demultiplexing unit 304.

(2) NIC 302

The NIC 302 is connected to the IP network, and receives a stream (right-view TS in the present embodiment) output from the external source.

The NIC 302 outputs the received right-view TS to the second demultiplexing unit 305.

(3) User Interface Unit 303

The user interface unit 303 receives a user instruction, such as the selection of a station or turning off power, via a remote control 330.

When the user interface unit 303 receives an instruction for selecting a station (i.e., instruction for changing a channel) from a user, the channel tuned by the tuner 301 is changed to the channel indicated by the instruction. This allows the tuner 301 to receive the broadcast waves corresponding to the station selected by the user.

When the user interface unit 303 receives an instruction for turning off power from the user, the playback device 10 is turned off.

(4) First Demultiplexing Unit 304

The first demultiplexing unit 304 demultiplexes the left-view TS received and demodulated by the tuner 301 into a left-view video stream including planar-view video images and left-view video images, SI/PSI, a subtitle stream, and an audio stream, and outputs the left-view video stream to the first video decoding unit 306, the subtitle stream to the subtitle decoding unit 308, and the audio stream to the audio decoding unit 310.

(5) Second Demultiplexing Unit 305

The second demultiplexing unit 305 demultiplexes the right-view TS received by the NIC 302 to obtain a right-view video stream including black screens and right-view video images, and outputs the right-view video stream to the second video decoding unit 307.

(6) First Video Decoding Unit 306

The first video decoding unit 306 decodes the left-view video stream received from the first demultiplexing unit 304 to obtain video images, and sequentially outputs the video images to the playback processing unit 312 according to a playback order. The output cycle for the video images is the same as the display cycle of a typical playback device (e.g., 1/60 seconds) so that a playback device capable of displaying only 2D video images can play back the output video images.

Also, the first video decoding unit 306 outputs, to the determination unit 311, the video identifiers included in pieces of supplementary data corresponding to the decoded video images.

(7) Second Video Decoding Unit 307

The second video decoding unit 307 decodes the right-view video stream received from the second demultiplexing unit 305 to obtain video images, and sequentially outputs the video images to the playback processing unit 312 according to a playback order.

The output cycle of the video images is the same as the output cycle used by the first video decoding unit 306.

(8) Subtitle Decoding Unit 308

The subtitle decoding unit 308 decodes the subtitle stream received from the first demultiplexing unit 304 to generate subtitles, and outputs the subtitles to the playback processing unit 312.

(9) OSD Creation Unit 309

The OSD creation unit 309 generates information indicating a channel number, the name of a broadcasting station, etc., so as to display the information together with the currently receiving program, and outputs the information (channel number, the name of the broadcasting station, etc.) to the playback processing unit 312.

(10) Audio Decoding Unit 310

The audio decoding unit 310 decodes the audio stream received from the first demultiplexing unit 304 to generate audio data, and outputs the audio data as audio via the speaker 313.

(11) Determination Unit 311

The determination unit 311 receives the video identifiers from the first video decoding unit 306, and determines, for each of the video identifiers, whether the video identifier indicates a planar-view video image or not, i.e., whether the decoded video image (video image to be played back) corresponding to the video identifier is a planar-view video image or a 3D video image (left-view video image), and outputs a result of the determination to the playback processing unit 312.

(12) Playback Processing Unit 312

As shown in FIG. 17, the playback processing unit 312 includes a first frame buffer 321, a second frame buffer 322, a frame buffer switching unit 323, a switching control unit 324, a superimposition unit 325, and a display unit 326.

The first frame buffer 321 is a storage area that stores the video images decoded by the first video decoding unit 306 on a per-video image (frame) basis.

The second frame buffer 322 is a storage area that stores the video images decoded by the second video decoding unit 307 on a per-video image (frame) basis.

The frame buffer switching unit 323 switches the buffer connecting to the superimposition unit 325 between the first frame buffer 321 and the second frame buffer 322, in order to switch the video images to be played back (to be output). Specifically, in the case of 3D playback, the frame buffer switching unit 323 alternately switches the buffer connecting to the superimposition unit 325 between the first frame buffer 321 and the second frame buffer 322. In this way, the left-view video images and the right-view video images are alternately played back, thus allowing for stereoscopic viewing. The cycle of the switching is 1/120 seconds, for example.

The switching control unit 324 controls the switching of the frame buffer switching unit 323. Specifically, when the determination result received from the determination unit 311 indicates that the video image to be played back is a planar-view video image for 2D playback, the switching control unit 324 controls the frame buffer switching unit 323 such that the first frame buffer 321 is connected to the superimposition unit 325 until the subsequent determination result indicates that the video image to be played back is not a planar-view video image. When the determination result received from the determination unit 311 indicates that the video image to be played back is not a planar-view video image for 2D playback, i.e., the video image to be played back is a 3D video image, the switching control unit 324 controls the frame buffer switching unit 323 such that the first frame buffer 321 and the second frame buffer 322 are alternately connected to the superimposition unit 325 at the display cycle of video images (e.g., 1/120 seconds).

The superimposition unit 325 reads a video image from the frame buffer connected thereto via the frame buffer switching unit 323, based on the display cycle ( 1/120 seconds) and, as necessary, superimposes subtitle data decoded by the subtitle decoding unit 308 and the information created by the OSD creation unit 309, and outputs the resultant video image to the display unit 326. The superimposition unit 325 reads a left-view video image (PL1), and reads a right-view video image after 1/120 seconds. When another 1/120 seconds have elapsed, the superimposition unit 325 reads a left-view video image from the first frame buffer 321. This left-view video image (PL2) differs from the left-view video image (PL1), since 1/60 seconds have elapsed after the left-view video image (PL1) is read. That is, a left-view video image and a right-view video image paired for 3D display are read once from the respective buffers during 1/60 seconds. On the other hand, when a planar-view video image is stored in the first frame buffer 321, the superimposition unit 325 reads the planar-view video image twice during the update cycle of the first frame buffer 321, i.e., during the time period ( 1/60 seconds) from when the planar-view video image is output from the first video decoding unit 306 to when the subsequent video image is output. In the case of 2D playback at a display cycle of 1/120 seconds, the same video image is displayed twice, which does not cause parallax. As such, the video image does not appear stereoscopic, thus allowing for monoscopic viewing.

The display unit 326 displays the video image received from the superimposition unit 325 on a display screen (not shown).

(13) Speaker 313

The speaker 313 outputs the audio data decoded by the audio decoding unit 310 as audio.

2.3. Operation

The following describes the operations of the transmission device 200 and the playback device 10.

2.3.1 Operation of Transmission Device 200

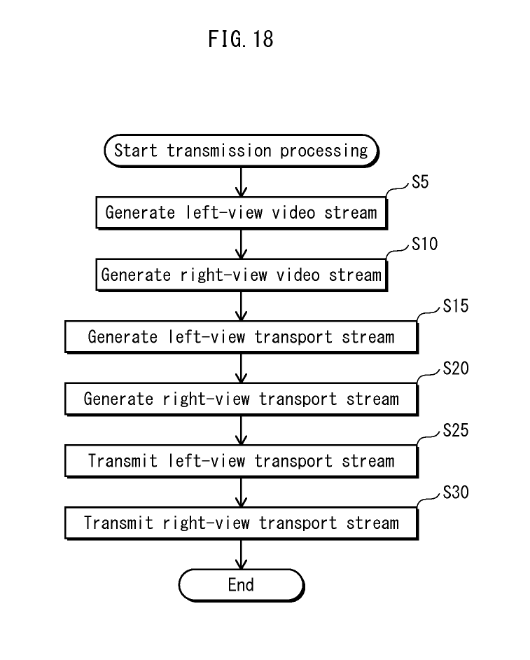

Here, description is provided on the transmission processing of the transmission device 200 with reference to the flowchart of FIG. 18.

The first video encoding unit 205 of the transmission device 200 generates a left-view video stream by encoding the left-view video images and the planar-view video images in the left-view group stored in the video storage unit 201, and stores the left-view video stream into the video stream storage unit 207 (step S5).

The second video encoding unit 206 generates a right-view video stream by encoding the right-view video images and the black screens in the right-view group stored in the video storage unit 201 (step S10).

The first multiplex processing unit 208 generates at least one TS in the MPEG 2-TS format by multiplexing the pieces of information stored in the stream management information storage unit 202, the subtitle stream storage unit 203, the audio stream storage unit 204, and the video stream storage unit 207, and stores the TS into the first transport stream storage unit 210 (step S15).

The second multiplex processing unit 209 generates at least one TS in the MPEG 2-TS format by multiplexing the right-view video stream generated in step S10, and stores the TS in the second transport stream storage unit 211 (step S20).

The first transmission unit 212 transmits the left-view TS stored in the first transport stream storage unit 210 as a broadcast wave (step S25).

The second transmission unit 213 transmits, to an external source, the right-view TS stored in the second transport stream storage unit 211 via the IP network (step S30).

2.3.2 Operation of Playback Device 10

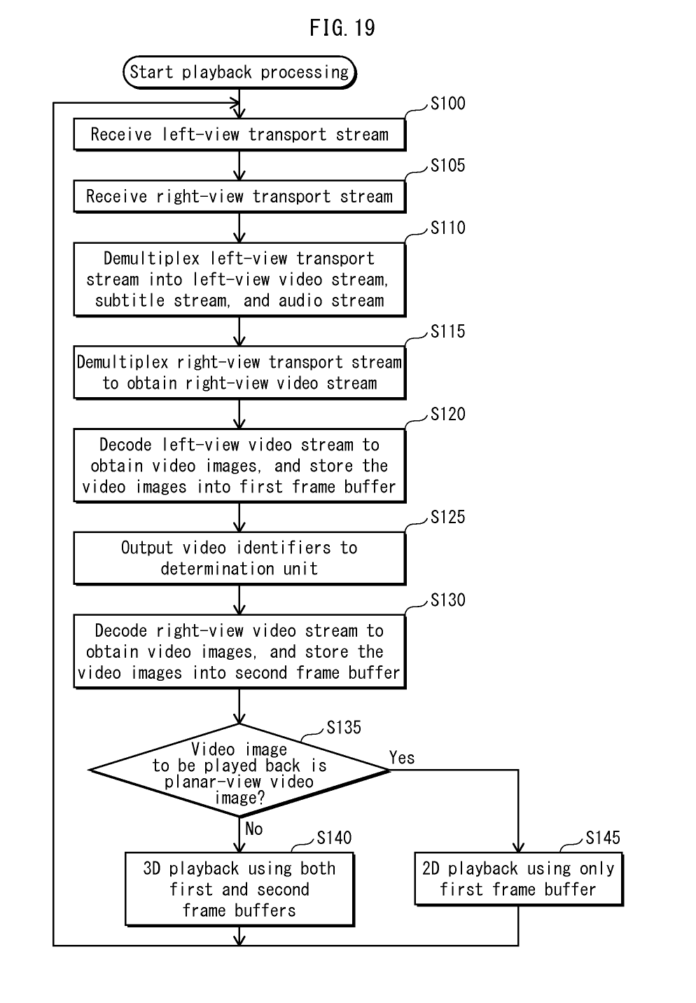

Here, description is provided on the playback processing of the playback device 10 with reference to the flowchart of FIG. 19.

The tuner 301 of the playback device 10 receives a left-view transport stream (step S100).

The NIC 302 receives a right-view transport stream (step S105).

The first demultiplexing unit 304 demultiplexes the left-view transport stream received by the tuner 301 into a left-view video stream, a subtitle stream, and an audio stream (step S110). The first demultiplexing unit 304 outputs the left-view video stream to the first video decoding unit 306, the subtitle stream to the subtitle decoding unit 308, and the audio stream to the audio decoding unit 310.

The second demultiplexing unit 305 demultiplexes the right-view transport stream received by the NIC 302 to obtain a right-view video stream (step S115). The second demultiplexing unit 305 outputs the right-view video stream to the second video decoding unit 307.

The first video decoding unit 306 decodes the left-view video stream to obtain video images, and stores the video images into the first frame buffer 321 (step S120).

The first video decoding unit 306 outputs, to the determination unit 311, the video identifiers included in pieces of supplementary data corresponding to the decoded video images (step S125).

The second video decoding unit 307 decodes the right-view video stream to obtain video images, and stores the video images into the second frame buffer 322 (step S130).

The determination unit 311 determines whether the video identifier corresponding to a video image to be played back indicates a planar-view video image or not (step S135).

When the determination unit 311 determines that the video image to be played back is not a planar-view video image (“No” in step S135), the switching control unit 324 causes the frame buffer switching unit 323 to alternately switch the connection between the first frame buffer 321 and the second frame buffer 322, whereby the playback processing unit 312 performs 3D playback using the video images stored in both the first frame buffer 321 and the second frame buffer 322 (step S140).

When the determination unit 311 determines that the video image to be played back is a planar-view video image (“Yes” in step S135), the switching control unit 324 causes the frame buffer switching unit 323 to switch the connection to the first frame buffer 321, whereby the playback processing unit 312 performs 2D playback using only the video image stored in the first frame buffer 321 (step S145).

2.4. Modifications

Although description has been provided based on the above embodiment, the present invention is not limited to the above embodiment. For example, the following modifications are possible.

(1) According to the above embodiment, the left-view video stream and the right-view video stream are generated with use of the same encoding method (MPEG-2 Video). However, the present invention is not limited to this.

The left-view video stream and the right-view video stream may be separately encoded with use of different encoding methods. For example, the left-view video stream may be encoded with use of the MPEG-2 Video standard, whereas the right-view video stream may be encoded with use of the MPEG-4 AVC standard.

(2) According to the above embodiment, the transmission device 200 stores the video identifiers into the pieces of supplementary data corresponding to the video images included in the left-view video stream. However, the present invention is not limited to such. The transmission device 200 may store the video identifiers into the pieces of supplementary data corresponding to the video images included in the right-view video stream.

In this case, the transmission device 200 stores, into the pieces of supplementary data corresponding to the black screens, video identifiers indicating that the black screens are planar-view video images, and stores, into the pieces of supplementary data corresponding to the right-view video images, video identifiers indicating that the right-view video images are not planar-view video images, i.e., that the right-view video images are 3D video images.

During decoding of the right-view video stream, the playback device 10 determines, for each decoded video image, whether the video identifier included in the supplementary data corresponding to the decoded video image indicates a planar-view video image or a 3D video image. When the video identifier indicates a planar-view video image, the playback device 10 causes the frame buffer switching unit 323 to switch the connection to the first frame buffer 321, and performs 2D playback using only the video image (planar-view video image) stored in the first frame buffer 321.

Note that during the 2D playback, the planar-view video images in the left-view video stream are played back. This is because of the following reasons. As shown in FIG. 11, the left-view video images are paired with the corresponding right-view video images along the playback time axis (in the presentation order). These video images need to be paired up to realize 3D display. Accordingly, it can be seen that the planar-view video images in the left-view video stream are paired with the black screens in the right-view video stream. As such, if, during decoding of the right-view video stream, the video identifier corresponding to a decoded video image indicates that the video image is a planar-view video image, the corresponding video image included in the left-view video stream is a planar-view video image. Accordingly, using the structure as described above can achieve 2D playback.

Also, suppose that the right-view video stream is encoded with use of the MPEG-4 AVC standard, and that the supplementary data including a video identifier is positioned before the compressed picture data as shown in FIG. 14. In this case, processing for decoding a compression-encoded video image (processing for decoding the compressed picture data I15 in FIG. 14) may be stopped. In this way, the decoding processing which accounts for the main part of the overall processing does not need to be performed. As a result, the power consumption of an LSI and a CPU used for the decoding processing can be reduced.

Inclusion of a video identifier in the right-view video stream as described above eliminates the need of including new information (video identifier in this example) in a signal transmitted via a typical broadcast wave. This can avoid a problem relating to compatibility, caused by a typical apparatus (i.e., an apparatus that does not receive video images via an IP network) receiving a signal with a video identifier and treating the video identifier as unexpected data.

(3) According to the above embodiment, the right-view video stream includes black screens instead of the same video images as the planar-view video images included in the left-view video stream. However, the present invention is not limited to such.

During the display of the planar-view video images in the left-view video stream, the video images in the right-view video stream with the same playback time as the planar-view video images in the left-view video stream are not displayed. Accordingly, instead of the black screens, the right-view video stream may include planar-view video images having a bit rate lower than the bit rate of the planar-view video images included in the left-view video stream.

(4) In the above embodiment, when it is determined that a video image to be played back is a 2D video image, the playback device 10 may stop receiving the right-view transport stream via the IP network.

In this case, the playback device 10 resumes the reception of the right-view transport stream via the IP network when a decoded video image in the left-view video stream is changed from a planar-view video image to a 3D video image.

By performing such a control as described above, the playback device 10 can reduce the power consumption thereof.

(5) Embodiment 1 and the modifications as described above may be combined with one another.

### 3. Embodiment 2

According to Embodiment 1, the planar-view video images are included only in the left-view video stream. In the present embodiment, however, description is provided on the case where planar-view video images are included in the right-view video stream as well.

3.1 Structure

A video transmission and reception system according to Embodiment 2 includes a digital television (playback device) 10a and a transmission device 200a.

The following describes the structures of the playback device 10a and the transmission device 200a, with a particular focus on the points differing from the structures of the playback device 10 and the transmission device 200 in Embodiment 1.

The same components as those in Embodiment 1 are provided with the same reference signs as in Embodiment 1, and a detailed description thereof is omitted.

3.1.1 Transmission Device 200a

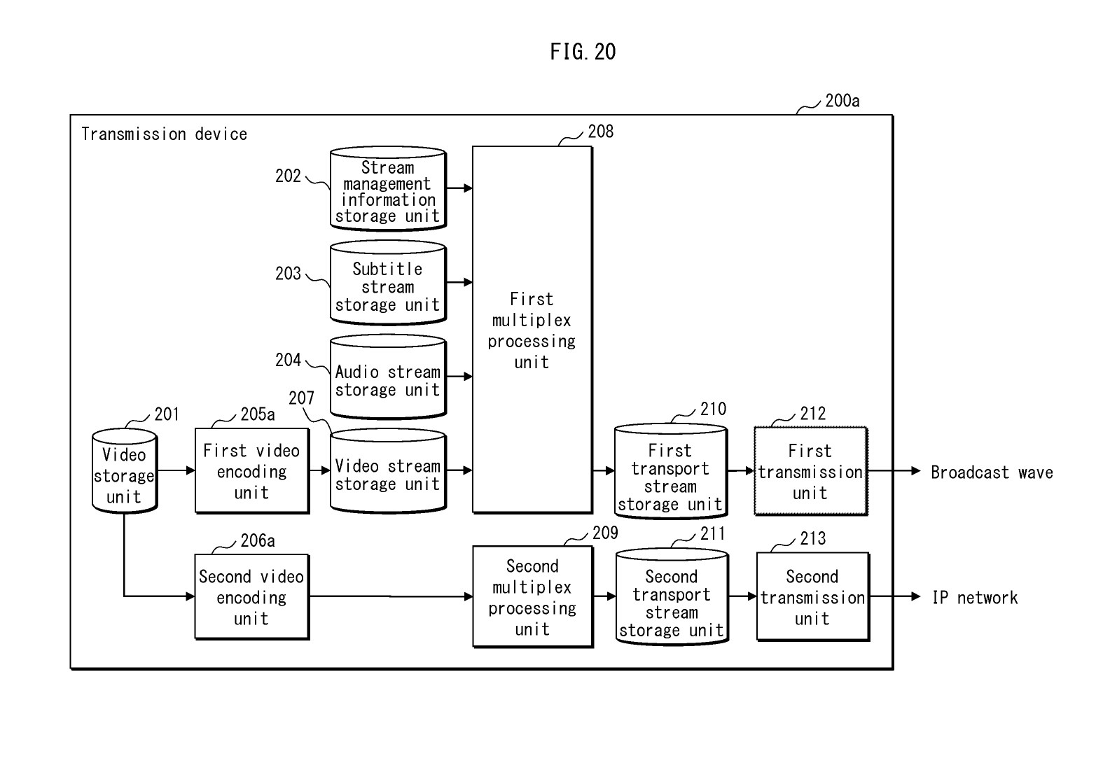

As shown in FIG. 20, the transmission device 200a includes a video storage unit 201, a stream management information storage unit 202, a subtitle stream storage unit 203, an audio stream storage unit 204, a first video encoding unit 205a, a second video encoding unit 206a, a video stream storage unit 207, a first multiplex processing unit 208, a second multiplex processing unit 209, a first transport stream storage unit 210, a second transport stream storage unit 211, a first transmission unit 212, and a second transmission unit 213.

The following describes the first video encoding unit 205a and the second video encoding unit 206a.

(1) Second Video Encoding Unit 206a

The second video encoding unit 206a encodes right-view video images and planar-view video images stored in the video storage unit 201, with use of the MPEG-4 AVC standard.

Specifically, the second video encoding unit 206a reads, from the video storage unit 201, the right-view video images and the planar-view video images in the right-view group according to a predetermined encoding order.

The second video encoding unit 206a compression-encodes the right-view video images and the planar-view video images thus read, and outputs the compression-encoded video images to the second multiplex processing unit 209.

(2) First Video Encoding Unit 205a

The first video encoding unit 205a encodes the left-view video images and the planar-view video images stored in the video storage unit 201. This encoding is performed with use of the MPEG-2 Video standard.

Specifically, the first video encoding unit 205a has the same functions as the first video encoding unit 205 in Embodiment 1, and further has the following functions.

Upon compression-encoding the planar-view video images, the first video encoding unit 205a compares the quality of the planar-view video images compression-encoded thereby with the quality of the corresponding planar-view video images compression-encoded by the second video encoding unit 206a. Then, the first video encoding unit 205a generates 2D quality flags indicating whether the planar-view video images compression-encoded thereby have higher quality than the planar-view video images compression-encoded by the second video encoding unit 206a, and stores the 2D quality flags in the pieces of supplementary data corresponding to the planar-view video images compression-encoded by the first video encoding unit 205a itself.

The following describes an example of determining the quality of a video image.

The quality of a video image can be determined, for example, by using the bit rate of the video image or by checking the presence of block noise. In the present embodiment, description is provided on the determination using the bit rate of a video image.

In general, the compression efficiency of the MPEG-4 AVC is approximately twice as high as that of MPEG-2 Video. Accordingly, if the bit rate of a video image in the MPEG-4 AVC is higher than half the bit rate of a video image in the MPEG-2 Video, it can be determined that the video image in the MPEG-4 AVC has higher quality.

3.1.2 Playback Device 10a

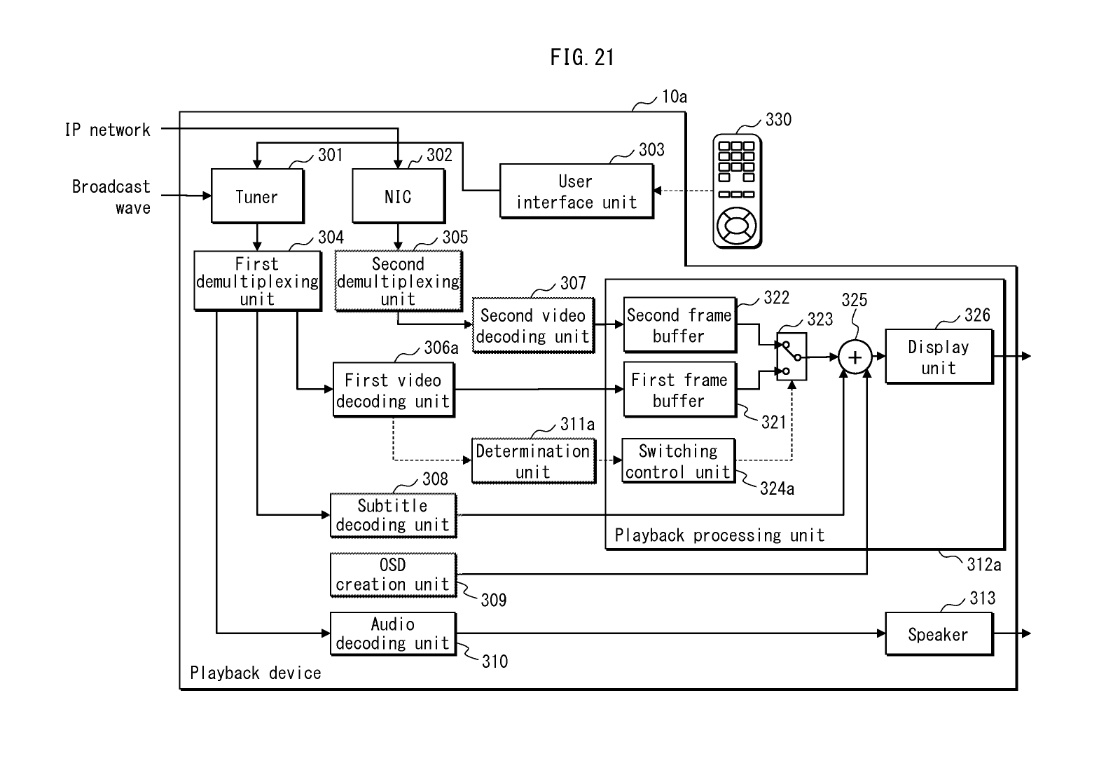

As shown in FIG. 21, the playback device 10a includes a tuner 301, an NIC 302, a user interface unit 303, a first demultiplexing unit 304, a second demultiplexing unit 305, a first video decoding unit 306a, a second video decoding unit 307, a subtitle decoding unit 308, an OSD creation unit 309, an audio decoding unit 310, a determination unit 311a, a playback processing unit 312a, and a speaker 313.

The following describes the first video decoding unit 306a, the determination unit 311a, and the playback processing unit 312a.

(1) First Video Decoding Unit 306a

The first video decoding unit 306a decodes the left-view video stream received from the first demultiplexing unit 304 to obtain video images, and sequentially outputs the video images to the playback processing unit 312 according to the playback order.

Also, the first video decoding unit 306a outputs, to the determination unit 311a, the video identifiers and the 2D quality flags included in pieces of supplementary data corresponding to the decoded video images.

(2) Determination Unit 311a

The determination unit 311a receives the video identifiers from the first video decoding unit 306a, and determines, for each of the video identifiers, whether the video identifier indicates a planar-view video image or not, i.e., whether the video image to be played back corresponding to the video identifier is a planar-view video image or a 3D video image.

When determining that the video image to be played back is a planar-view video image, the determination unit 311a uses the corresponding 2D quality flag received from the first video decoding unit 306a to determine whether the planar-view video image decoded by the first video decoding unit 306a has higher quality than the corresponding planar-view video image decoded by the second video decoding unit 307.

The determination unit 311a outputs, to the playback processing unit 312a, a result of the determination of whether the video image to be played back is a planar-view video image or a 3D video image. Also, when having performed the determination regarding the quality of a planar-view video image, the determination unit 311a outputs a result of the determination to the playback processing unit 312a.

(3) Playback Processing Unit 312a

As shown in FIG. 21, the playback processing unit 312a includes a first frame buffer 321, a second frame buffer 322, a frame buffer switching unit 323, a switching control unit 324a, a superimposition unit 325, and a display unit 326.

Details of the first frame buffer 321, the second frame buffer 322, the frame buffer switching unit 323, the superimposition unit 325, and the display unit 326 are described in Embodiment 1. Accordingly, descriptions thereof are omitted here, and the following only describes the switching control unit 324a.

The switching control unit 324a controls the switching of the frame buffer switching unit 323. Specifically, when the determination result received from the determination unit 311a indicates that the video image to be played back is a planar-view video image, and the determination result regarding the quality of the planar-view video image indicates that the planar-view video image decoded by the first video decoding unit 306a has higher quality than the corresponding planar-view video image decoded by the second video decoding unit 307, then the switching control unit 324a causes the frame buffer switching unit 323 to switch the connection to the first frame buffer 321. On the other hand, when the determination result received from the determination unit 311a indicates that the video image to be played back is a planar-view video image, and the determination result regarding the quality of the planar-view video image indicates that the planar-view video image decoded by the first video decoding unit 306a does not have higher quality, then the switching control unit 324a causes the frame buffer switching unit 323 to switch the connection to the second frame buffer 322.

When the determination result received from the determination unit 311a indicates that the video image to be played back is not a planar-view video image, i.e., that the video image to be played back is a 3D video image, the switching control unit 324a causes the frame buffer switching unit 323 to alternately switch the connection between the first frame buffer 321 and the second frame buffer 322 at a cycle of 120 Hz.

3.2 Operation

3.2.1 Operation of Transmission Device 200a

The following describes the transmission processing of the transmission device 200a. Specifically, in the following, description is provided on only the differences from the transmission processing of the transmission device 200 in Embodiment 1 with reference to the flowchart of FIG. 18.

In the transmission processing of the transmission device 200a, the order of step S5 and step S10 in FIG. 18 is switched around. In step S5, the transmission device 200a performs determination regarding the quality of video images, and stores the determination results in the respective pieces of supplementary data corresponding to the video images included in the left-view video stream.

The order of the operations from step S15 onwards remains the same.

3.2.2 Operation of Playback Device 10a

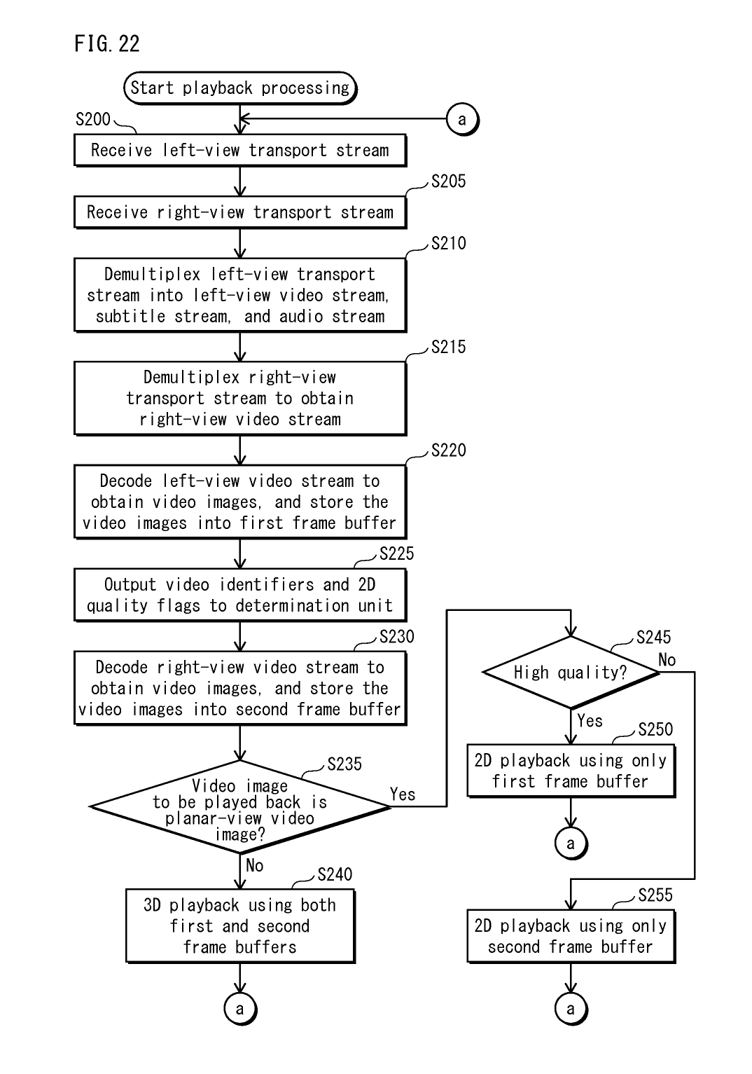

Here, description is provided on the playback processing of the playback device 10a with reference to the flowchart of FIG. 22.

Steps S200 to S220 in FIG. 22 are the same as steps S100 to S120 in FIG. 19. Accordingly, description thereof is omitted here.

After step S220, the first video decoding unit 306a outputs the video identifiers corresponding to the decoded video images and the 2D quality flags to the determination unit 311a (step S225).

The second video decoding unit 307 decodes the right-view video stream to obtain video images, and stores the video images into the second frame buffer 322 (step S230).

The determination unit 311a determines whether the video identifier corresponding to a video image to be played back indicates a planar-view video image or not (step S235).

When the determination unit 311a determines that the video image to be played back is not a planar-view video image (“No” in step S235), the switching control unit 324a causes the frame buffer switching unit 323 to alternately switch the connection between the first frame buffer 321 and the second frame buffer 322, whereby the playback processing unit 312a performs 3D playback using the video images stored in both the first frame buffer 321 and the second frame buffer 322 (step S240).

When the determination unit 311a determines that the video image to be played back is a planar-view video image (“Yes” in step S235), the determination unit 311a further determines whether the planar-view video image decoded by the first video decoding unit 306a has higher quality than the corresponding planar-view video image decoded by the second video decoding unit 307, with use of the 2D quality flag (step S245).

When the determination unit 311a determines that the planar-view video image decoded by the first video decoding unit 306a has higher quality (“Yes” in step S245), the switching control unit 324a causes the frame buffer switching unit 323 to switch the connection to the first frame buffer 321, whereby the playback processing unit 312a performs 2D playback using the video images stored in the first frame buffer 321 (step S250).

When the determination unit 311a determines that the planar-view video image decoded by the first video decoding unit 306a does not have higher quality (“No” in step S245), the switching control unit 324a causes the frame buffer switching unit 323 to switch the connection to the second frame buffer 322, whereby the playback processing unit 312a performs 2D playback using the video images stored in the second frame buffer 321 (step S255).

3.3 Modifications 1

According to Embodiment 2, the qualities of two identical planar-view video images are determined, and the planar-view video image having higher quality is played back in preference to the other planar-view video image. Regarding viewing of 3D video images, the viewer may wish to view the 3D video images in monoscopic presentation, i.e., in 2D playback due to eyestrain or the like.

Accordingly, in Modification 1, description is provided on a function of switching from 3D playback to 2D playback according to an instruction from the viewer.

A video transmission and reception system according to Modification 1 includes a digital television (playback device) 10b and a transmission device 200b.

The following describes the structures of the playback device 10b and the transmission device 200b, with a particular focus on the points differing from the structures of the corresponding devices in Embodiments 1 and 2.

The same components as those in Embodiments 1 and 2 are provided with the same reference signs as in Embodiments 1 and 2, and a detailed description thereof is omitted.

3.3.1 Transmission Device 200b

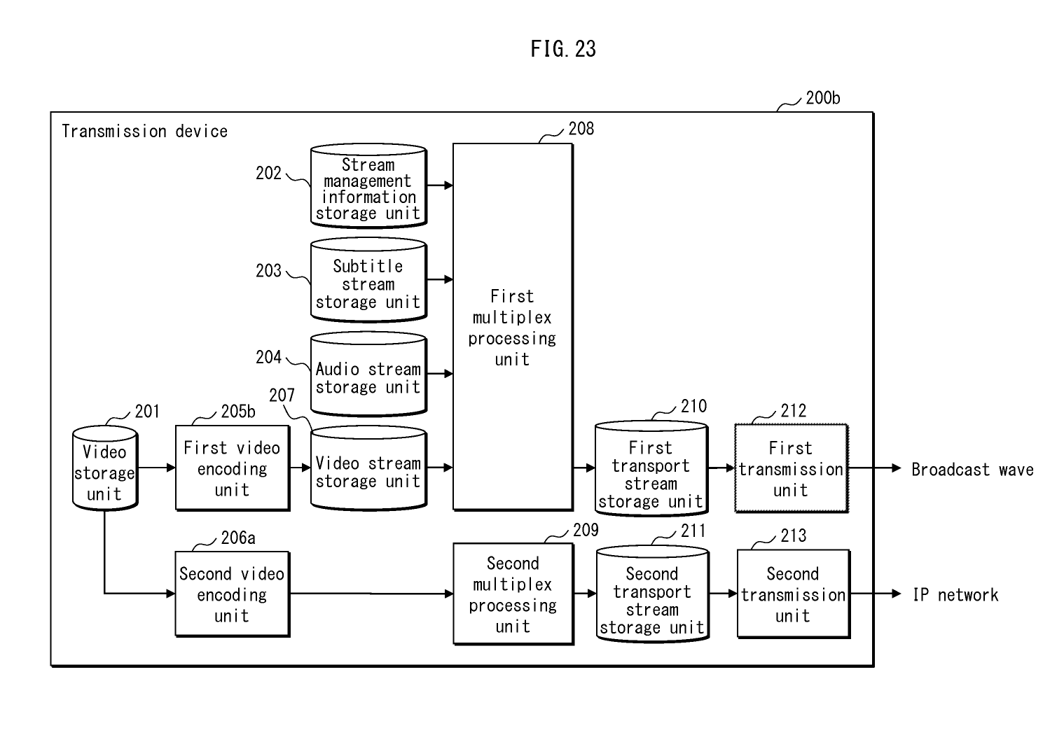

As shown in FIG. 23, the transmission device 200b includes a video storage unit 201, a stream management information storage unit 202, a subtitle stream storage unit 203, an audio stream storage unit 204, a first video encoding unit 205b, a second video encoding unit 206a, a video stream storage unit 207, a first multiplex processing unit 208, a second multiplex processing unit 209, a first transport stream storage unit 210, a second transport stream storage unit 211, a first transmission unit 212, and a second transmission unit 213.

The following describes the first video encoding unit 205b.

(1) First Video Encoding Unit 205b

The first video encoding unit 205b encodes the left-view video images and the planar-view video images stored in the video storage unit 201. This encoding is performed with use of the MPEG-2 Video standard.

Specifically, the first video encoding unit 205b has the same functions as the first video encoding unit 205a in Embodiment 2, and further has the following functions.

Upon compression-encoding the 3D video images (left-view video images), the first video encoding unit 205b compares the quality of the 3D video images compression-encoded thereby with the quality of the corresponding 3D video images (right-view video images) compression-encoded by the second video encoding unit 206a. Then, the first video encoding unit 205b generates 3D quality flags indicating whether the 3D video images compression-encoded thereby have higher quality than the 3D video images compression-encoded by the second video encoding unit 206a, and stores the 3D quality flags in the pieces of supplementary data corresponding to the 3D video images compression-encoded by the first video encoding unit 205b itself.

The determination regarding the quality of 3D video images is performed in the same manner as the determination regarding the quality of planar-view video images described in Embodiment 2. Accordingly, description thereof is omitted.

3.3.2 Playback Device 10b

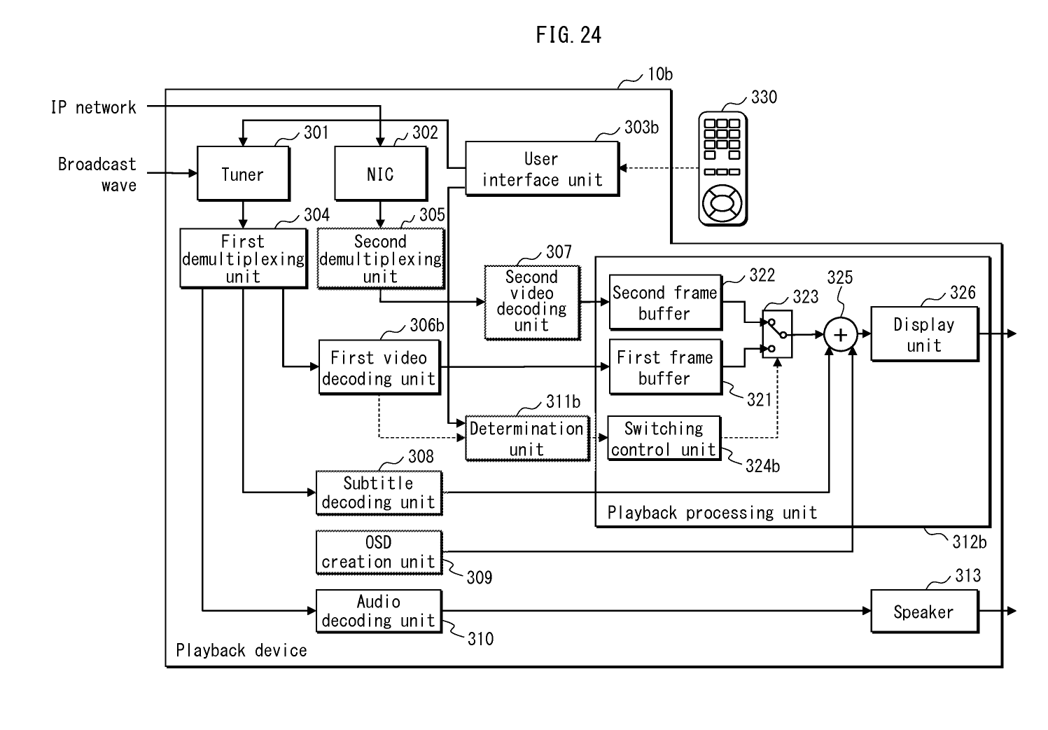

As shown in FIG. 24, the playback device 10b includes a tuner 301, an NIC 302, a user interface unit 303b, a first demultiplexing unit 304, a second demultiplexing unit 305, a first video decoding unit 306b, a second video decoding unit 307, a subtitle decoding unit 308, an OSD creation unit 309, an audio decoding unit 310, a determination unit 311b, a playback processing unit 312b, and a speaker 313.

The following describes the user interface unit 303b, the first video decoding unit 306b, the determination unit 311b, and the playback processing unit 312b.

(1) User Interface Unit 303b

The user interface unit 303b has the same functions as the user interface unit 303 in Embodiment 1, and further has the following functions.

The user interface unit 303b receives a viewing mode changing instruction from the user. The viewing mode changing instruction indicates that the viewing mode of 3D video images is to be changed from 3D playback to 2D playback or vice versa. The user interface unit 303b notifies the viewing mode changing instruction thus received to the determination unit 311b.

(2) First Video Decoding Unit 306b

The first video decoding unit 306b decodes the left-view video stream received from the first demultiplexing unit 304 to obtain video images, and sequentially outputs the video images to the playback processing unit 312b according to the playback order.

Also, the first video decoding unit 306b outputs, to the determination unit 311b, the video identifiers, the 2D quality flags, and the 3D quality flags included in pieces of supplementary data corresponding to the decoded video images.

(3) Determination Unit 311b

The determination unit 311b has the same functions as the determination unit 311a in Embodiment 2, and further has the following functions.

The determination unit 311b receives the viewing mode changing instruction from the user interface unit 303b. When the viewing mode changing instruction indicates the changing from 3D playback to 2D playback, and a video image to be played back is a 3D video image, then the determination unit 311b determines whether the 3D video image (left-view video image) decoded by the first video decoding unit 306b has higher quality than the 3D video image (right-view video image) decoded by the second video decoding unit 307, with use of the 3D quality flag received from the first video decoding unit 306b.

If the determination unit 311b has performed the determination regarding the quality of a 3D video image, the determination unit 311 outputs a result of the determination to the playback processing unit 312b.

When the viewing mode changing instruction received from the user interface unit 303b indicates the changing from 2D playback to 3D playback, the determination unit 311b does not perform determination regarding the quality of a 3D video image.

(3) Playback Processing Unit 312b

As shown in FIG. 24, the playback processing unit 312b includes a first frame buffer 321, a second frame buffer 322, a frame buffer switching unit 323, a switching control unit 324b, a superimposition unit 325, and a display unit 326.

Details of the first frame buffer 321, the second frame buffer 322, the frame buffer switching unit 323, the superimposition unit 325, and the display unit 326 are described in Embodiment 1. Accordingly, descriptions thereof are omitted here, and the following only describes the switching control unit 324b.

The switching control unit 324b controls the switching of the frame buffer switching unit 323. The switching control unit 324b has the same functions as the switching control unit 324a in Embodiment 2, and further has the following functions.

When the determination result received from the determination unit 311b indicates that the video image to be played back is a 3D video image, and the determination result regarding the quality of the 3D video image indicates that the 3D video image decoded by the first video decoding unit 306b has better quality than the corresponding 3D video image decoded by the second video decoding unit 307, then the switching control unit 324b causes the frame buffer switching unit 323 to switch the connection to the first frame buffer 321. On the other hand, when the determination result received from the determination unit 311b indicates that the video image to be played back is a 3D video image, and the determination result regarding the quality of the 3D video image indicates that the 3D video image decoded by the first video decoding unit 306b does not have better quality, then the switching control unit 324b causes the frame buffer switching unit 323 to switch the connection to the second frame buffer 322.

When the determination result received from the determination unit 311b indicates that the video image to be played back is not a planar-view video image, i.e., that the video image to be played back is a 3D video image, and the determination result regarding the quality of the 3D video image is not received, then the switching control unit 324b causes the frame buffer switching unit 323 to alternately switch the connection between the first frame buffer 321 and the second frame buffer 322 at a cycle of 120 Hz.

3.3.3 Operation

(1) Operation of Transmission Device 200b

The following describes the transmission processing of the transmission device 200b. Specifically, in the following, description is provided on only the differences from the transmission processing of each of the transmission devices in Embodiments 1 and 2 with reference to the flowchart of FIG. 18.

In the transmission processing of the transmission device 200b, the order of step S5 and step S10 in FIG. 18 is switched around. In step S5, the transmission device 200b performs determination regarding the quality of planar-view video images, and stores the determination results as 2D quality flags in the pieces of supplementary data corresponding to the planar-view video images included in the left-view video stream. Also, the transmission device 200b performs determination regarding the quality of 3D video images, and stores the determination results as 3D quality flags in the pieces of supplementary data corresponding to the 3D video images included in the left-view video stream.

The order of the operations from step S15 onwards remains the same.

(2) Operation of Playback Device 10b

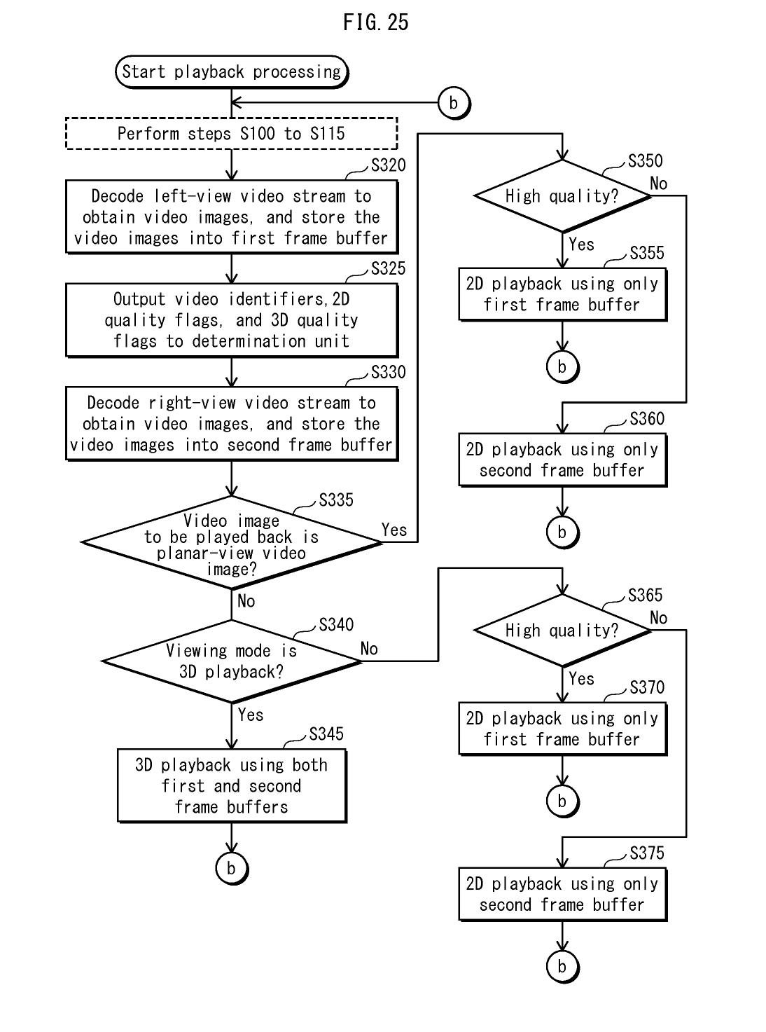

Here, description is provided on the playback processing of the playback device 10b with reference to the flowchart of FIG. 25.

The playback device 10b performs steps S100 to S115 in FIG. 19.

The first video decoding unit 306b of the playback device 10b decodes the left-view video stream to obtain video images, and stores the video images into the first frame buffer 321 (step S320).

The first video decoding unit 306b outputs, to the determination unit 311b, the video identifiers corresponding to the decoded video images, the 2D quality flags, and the 3D quality flags to the determination unit 311b (step S325).

The second video decoding unit 307 decodes the right-view video stream to obtain video images, and stores the video images into the second frame buffer 322 (step S330).

The determination unit 311b determines whether the video identifier corresponding to a video image to be played back indicates a planar-view video image or not (step S335).

When determining that the video image to be played back is not a planar-view video image (“No” in step S335), the determination unit 311b determines whether the viewing mode changing instruction received from the user interface unit 303b indicates the changing from 3D playback to 2D playback, i.e., whether the current viewing mode is 3D playback or not (step S340).

When the determination unit 311b determines that the current viewing mode is 3D playback (“Yes” in step S340), the switching control unit 324b causes the frame buffer switching unit 323 to alternately switch the connection between the first frame buffer 321 and the second frame buffer 322, whereby the playback processing unit 312b performs 3D playback using the video images stored in both the first frame buffer 321 and the second frame buffer 322 (step S345).

When determining that the video image to be played back is a planar-view video image (“Yes” in step S335), the determination unit 311b further determines whether the planar-view video image decoded by the first video decoding unit 306b has better quality than the corresponding planar-view video image decoded by the second video decoding unit 307, with use of the 2D quality flag (step S350).

When the determination unit 311b determines that the planar-view video image decoded by the first video decoding unit 306b has higher quality (“Yes” in step S350), the switching control unit 324b causes the frame buffer switching unit 323 to switch the connection to the first frame buffer 321, whereby the playback processing unit 312b performs 2D playback using the video images (planar-view video images) stored in the first frame buffer 321 (step S355).

When the determination unit 311b determines that the planar-view video image decoded by the first video decoding unit 306b does not have higher quality (“No” in step S350), the switching control unit 324b causes the frame buffer switching unit 323 to switch the connection to the second frame buffer 322, whereby the playback processing unit 312b performs 2D playback using the video images stored in the second frame buffer 322 (step S360).

When the determination unit 311b determines that the current viewing mode is not 3D playback, i.e., the current viewing mode is 2D playback (“No” in step S340), the determination unit 311b further determines whether the 3D video image (left-view video image) decoded by the first video decoding unit 306b has higher quality than the 3D video image (right-view video image) decoded by the second video decoding unit 307, with use of the 3D quality flag (step S365).

When the determination unit 311b determines that the 3D video image decoded by the first video decoding unit 306b has higher quality (“Yes” in step S365), the switching control unit 324b causes the frame buffer switching unit 323 to switch the connection to the first frame buffer 321, whereby the playback processing unit 312b performs 2D playback using the video images (left-view video images) stored in the first frame buffer 321 (step S370).

When the determination unit 311b determines that the 3D video image decoded by the first video decoding unit 306b does not have higher quality (“No” in step S365), the switching control unit 324b causes the frame buffer switching unit 323 to switch the connection to the second frame buffer 322, whereby the playback processing unit 312b performs 2D playback using the video images (right-view video images) stored in the second frame buffer 322 (step S375).

3.4 Other Modifications

Although description has been provided based on the above embodiment 2 and Modification 1, the present invention is not limited to such. For example, the following modifications are possible.

(1) According to Embodiment 2 above, the transmission device 200a stores the 2D quality flags in the pieces of supplementary data corresponding to the planar-view video images in the left-view video stream. The transmission device 200a may store the 2D quality flags in the pieces of supplementary data corresponding to the planar-view video images in the right-view video stream. In a case where the right-view video stream is generated according to the MPEG-4 AVC standard, the supplementary data is user data in SEI (Supplemental Enhancement Information).

During decoding of a planar-view video image in the right-view video stream, the playback device 10b determines whether the 2D quality flag included in the supplementary data corresponding to the decoded planar-view video image indicates that the planar-view video image has higher quality than the corresponding planar-view video image in the left-view video stream. When determining that the planar-view video image in the right-view video stream has higher quality, the playback device 10b causes the frame buffer switching unit 323 to switch the connection to the second frame buffer 322, and performs 2D playback using only the video image stored in the second frame buffer 322. When determining that the planar-view video image in the right-view video stream does not have higher quality, the playback device 10b causes the frame buffer switching unit 323 to switch the connection to the first frame buffer 321, and performs 2D playback using only the video image stored in the first frame buffer 321.

As an alternative to the above, the 2D quality flags may be stored in the pieces of supplementary data corresponding to the planar-video images in both the left-view video stream and the right-view video stream.

Similarly, the 3D quality flags may be stored in the pieces of supplementary data corresponding to the 3D video images included in the right-view video stream.

In this case, during decoding of a 3D video image in the right-view video stream, the playback device 10b determines whether the 3D quality flag included in the supplementary data corresponding to the decoded 3D video image (right-view video image) has higher quality than the corresponding 3D video image (left-view video image) included in the left-view video stream. When determining that the 3D video image in the right-view video stream has higher quality, the playback device 10b causes the frame buffer switching unit 323 to switch the connection to the second frame buffer 322, and performs 2D playback using only the video image (right-view video image) stored in the second frame buffer 322. When determining that the 3D video image in the right-view video stream does not have higher quality, the playback device 10b causes the frame buffer switching unit 323 to switch the connection to the first frame buffer 321, and performs 2D playback using only the video image (left-view video image) stored in the first frame buffer 321.

As an alternative to the above, the 3D quality flags may be stored in the pieces of supplementary data corresponding to the 3D video images in both the left-view video stream and the right-view video stream.

(2) According to Embodiment 2, the 2D quality flag is associated with each planar-view video image in order to identify whether the planar-view video image has higher quality or not. However, no limitation is intended thereby.

Instead of the 2D quality flags, playback information for planar-view video images (hereinafter “2D playback information) may be included in a PMT (Program Map Table) defined in the MPEG-2 Video standard. The 2D playback information indicates whether to use the planar-view video images in the left-view video stream or the planar-view video images in the right-view video stream to perform 2D playback, regardless of which planar-view video images have higher quality. In this way, the playback device does not need to perform switching in units of video images. Instead, the playback device can perform switching at predetermined time intervals (e.g., 100 msec).

Alternatively, the 2D playback information may be included in an EIT defined in the MPEG-2 Video standard. This allows for specifying, for each program, whether to use the planar-view video images in the left-view video stream or the planar-view video images in the right-view video stream.

In a case where broadcast waves are transmitted according to the ATSC standard, the 2D playback information may be included in a VCT (Virtual Channel Table) or an EIT (Event Information Table). The VCT and the EIT are defined in section 6.3 and section 6.5, respectively, in ATSC standard a-65c. The VCT relates to a current broadcast program, and includes information regarding the channel number of the program, and “sourceid” associated one-to-one with a virtual channel (majornum. and minornum.). The EIT relates to a current broadcast program and a subsequent broadcast program, and includes “sourceid” and program information for each of the programs. The program information indicates a program name, a broadcast start time, a broadcast end time, etc.

In the case of including the 2D playback information in the VCT, the 2D playback information is defined in the reserved field within “num_channels_in_section”. Alternatively, the 2D playback information may be defined as descriptor ( ) within “num_channels_in_section”.

In the case of including the 2D playback information in the EIT, the 2D playback information is defined in the reserved field within “num_events_in_section”, for example. Alternatively, the 2D playback information may be defined as descriptor ( ) within “num_events_in_section”.

(3) According to Modification 1 above, the 3D quality flag is associated with each 3D video image in order to identify whether the 3D video image has higher quality or not. However, no limitation is intended thereby.

Instead of the 3D quality flags, playback information for 3D video images (hereinafter “3D playback information”) may be included in the pieces of supplementary data corresponding to the left-view video images included in the left-view video stream. The 3D playback information indicates whether to use the left-view video images in the left-view video stream or the right-view video images in the right-view video stream to perform 2D playback, regardless of which video images have higher quality.

For example, in a case where the 3D video images constitute a movie or the like, the creator of the 3D video images (the producer of the movie) may determine in advance whether to use the left-view video images or the right-view video images to perform 2D playback. For example, one movie producer may determine that the left-view video images should be used for 2D playback, while another may determine that the right-view video images should be used for 2D playback. In such a case, the use of the 3D playback information allows for 2D playback reflecting the intention of a movie producer.

It is beneficial to use the 3D playback information, since it makes it possible to switch the video images to be output for 2D playback on a per-frame basis between the video images transmitted via a broadcast wave and the video images transmitted via the IP network. However, from the viewpoint of a receiver of hybrid 3D broadcasts, switching on a per-frame (per-video image) basis may lead to the burden of implementation since a frame buffer switching unit needs to perform switching frequently. Accordingly, a limitation may be imposed to prevent such a frequent switching operation. Such a limitation may be that 10 or more frames must be sequentially output from the same channel (i.e., 10 or more frames must be sequentially output either via a broadcast wave or via the IP network). This prevents the playback device to frequently perform switching, and allows for flexible switching within a program. For example, in the section A of a program, left-view video images may be used for 2D display, and in the section B of the same program, right-view video images may be used for 2D display.

The following describes a specific example of a storage location of the 3D playback information for preventing a frequent switching operation.

The 3D playback information may be included in a PMT defined in the MPEG-2 Video standard. In this case, the playback device reads the 3D playback information in the PMT and, based on the 3D playback information, determines whether to use the left-view video images or the right-view video images for 2D playback. Then, as a result of the determination, the playback device switches the connection of the frame buffer switching unit to perform 2D playback. In this way, the playback device does not need to perform switching in units of video images. Instead, the playback device can perform switching at predetermined time intervals (e.g., 100 msec).

Alternatively, the 3D playback information may be included in the EIT defined in the MPEG-2 Video standard. This allows for specifying, for each program, whether to use the planar-view video images in the left-view video stream or the planar-view video images in the right-view video stream.

Alternatively, the 3D playback information may be included in a VCT (Virtual Channel Table) or an EIT (Event Information Table) defined in the ATSC standard.

In the case of including the 3D playback information in the VCT, the 3D playback information is defined in the reserved field within “num_channels_in_section”. Alternatively, the 3D playback information may be defined as descriptor ( ) within “num_channels_in_section”.

In the case of including the 3D playback information in the EIT, the 3D playback information may be defined in the reserved field within “num_events_in_section”, for example. Alternatively, the 3D playback information may be defined as descriptor ( ) within “num_events_in_section”.

Description is omitted on the operations of the playback device in a case where the 3D playback information is stored in the EIT defined in the MPEG-2 Video standard or in the VCT or EIT defined in the ATSC standard. This is because the concept of the operations of the playback device is basically the same whether the 3D playback information is stored in the PMT, in the EIT defined in the MPEG-2 Video standard, or in the VCT or EIT defined in the ATSC standard. The only difference is the reading location, i.e., the PMT, EIT, VCT, and EIC, from which the 3D playback information is read by the playback device.

(4) The 2D playback information and the 3D playback information described above are assumed to be included in the transport stream transmitted as a broadcast wave. However, no limitation is intended thereby.

The 2D playback information and the 3D playback information may be included in the transport stream transmitted via the IP network.

Alternatively, prior to the transmission of the transport stream (right-view video stream) via the IP network, the transmission device may transmit a playback control file including the 2D playback information and the 3D playback information via the IP network.

A similar description applies to the 2D quality flags and the 3D quality flags. That is, prior to the transmission of the transport stream (right-view video stream) via the IP network, the transmission device may transmit a playback control file including the 2D quality flags and the 3D quality flags via the IP network.

(5) According to Embodiment 2, the playback device 10a determines the quality of planar-view video images with use of the 2D quality flags. However, no limitation is intended thereby.

The playback device 10a may compare the bit rate of a planar-view video image included in the left-view video stream with the bit rate of a planar-view video image included in the right-view video stream, and may thereby determine which planar-view video image has higher quality. In other words, similarly to the transmission device 200a, the playback device 10a may determine the quality of a planar-view video image included in the left-view video stream and the quality of a planar-view video image included in the right-view video stream.

According to Modification 1, the playback device 10b determines the quality of a left-view video image and the quality of a right-view video image with use of the corresponding 3D quality flag. However, no limitation is intended thereby.

The playback device 10b may compare the bit rate of a left-view video image with the bit rate of a right-view video image, and may thereby determine which video image has higher quality. In other words, similarly to the transmission device 200b, the playback device 10b may determine the quality of a left-view video image and the quality of a right-view video image.

(6) The transport stream (TS) transmitted via the IP network does not always need to be a single TS. Instead, a plurality of TSs may be prepared for right-view video images, where each of the TSs has a different bit rate according to the bandwidth of the network.

The following describes an example in which two TSs (referred to as “TS1” and “TS2” in the present example), each having a different bit rate, are prepared for the IP network. Suppose that the TS1 with a relatively high bit rate has higher quality than the TS transmitted as a broadcast wave. In this case, the SEI of the TS1 may include a 3D quality flag indicating that the right-view video images in the TS1 should be used for 2D playback. Furthermore, suppose that the TS2 with a relatively low bit rate has lower quality than the TS transmitted as a broadcast wave. In this case, the SEI of the TS2 may include a 3D quality flag indicating that the left-view video images transmitted as the broadcast wave should be used for 2D playback.

Also, there is a possibility that the playback device cannot determine whether the right-view video images received via the IP network has higher quality than the left-view video images received via the broadcast wave, with use of the TS transmitted as a broadcast wave. To address this problem, the supplementary data of each video image (MPEG-2 Video) transmitted via the broadcast wave may include information indicating that “determination on whether 2D playback is performed with use of the video images transmitted as the broadcast wave or the video images transmitted via the IP network is performed based on the information in the video images transmitted via the IP network”.

Alternatively, the transmission device may include a table in the TS transmitted as a broadcast wave, the table showing the respective bit rates of the TS1 and TS2, and the bit rate of the TS transmitted as a broadcast wave. In this way, the playback device can determine whether the right-view video images received via the IP network have higher quality than the left-view video images received via the broadcast wave by using only the TS transmitted as the broadcast wave, without using the TS (TS1 or TS2) received via the IP network.

(7) According to Embodiment 2, during playback of planar-view video images, the playback device 10a plays back the planar-view video image having higher quality between a planar-view video image in the left-view video stream and a planar-view video image in the right-view video stream. However, no limitation is intended thereby.

The playback device 10a may play back the planar-view video image having lower quality between a planar-view video image in the left-view video stream and a planar-view video image in the right-view video stream.

Also, according to Modification 1, when the viewing mode of a 3D program is changed from 3D playback to 2D playback, the playback device 10b plays back the video image having higher quality between a left-view video image and a right-view video image. However, no intention is intended thereby.

The playback device 10b may perform 2D playback with use of the video image having lower quality between a left-view video image and a right-view video image.

(8) Embodiment 2 and the modifications as described above may be combined with one another.

### 4. Modifications

The present invention is not limited to the above embodiments, etc. For example, the following modifications are possible.

(1) According to the above embodiments, etc., the left-view video images are transmitted as a broadcast wave, and the right-view video images are transmitted via the IP network. However, no limitation is intended thereby.

The left-view video images may be transmitted via the IP network, and the right-view video images may be transmitted as a broadcast wave.

Alternatively, the transport stream including the left-view video images and the transport stream including the right-view video images may be transmitted as broadcast waves via different transmission channels.

Yet alternatively, the transport stream including the left-view video images and the transport stream including the right-view video images may be separately transmitted via the IP network.

(2) According to the above embodiments, etc., the display cycle during 2D playback is the same as the display cycle during 3D playback. However, no limitation is intended thereby. The display cycle during 2D playback may be the same as the display cycle (e.g., 1/60 seconds) of a typical playback device.

(3) According to the above embodiments, etc., the right-view video images, which are transmitted and received via the IP network, are included in a transport stream according to either the MPEG-2 Video standard or the MPEG-4 AVC standard. However, no limitation is intended thereby.

The right-view video images may be included in a file in MP4 format or in a format other than the MP4 format, and may then be transmitted and received via the IP network.

(4) The above devices are, specifically, a computer system composed of a microprocessor, a ROM, a RAM, a hard disk unit, a display unit, a keyboard, a mouse, etc. A computer program is stored on the RAM or the hard disk unit. The microprocessor operates in accordance with the computer program, whereby each of the devices achieves its functions. In order to achieve predetermined functions, the computer program is composed of a combination of multiple command codes that indicate instructions for the computer.

(5) Part or all of the components constituting each of the above devices may be assembled as one integrated circuit.

(6) Part or all of the components constituting each of the above devices may be constructed from an IC card or a single module attachable to and detachable from each device. The IC card and the module are each a computer system composed of a microprocessor, a ROM, a RAM, etc. The IC card and the module may include the ultra-multifunctional LSI as described above. The microprocessor operates according to the computer program, whereby the IC card or the module achieves its functions.

(7) The methods described in the above embodiments and modifications may be realized by storing a program including the description of the procedures of the methods into a memory and causing a CPU (Central Processing Unit) or the like to read the program from the memory and execute the program.

Alternatively, the program including the description of the procedures of the methods may be stored onto a recording medium and may be distributed. Examples of such a recording medium include an IC card, a hard disk, an optical disc, a flexible disk, a ROM, and a flash memory.

(8) The above embodiments and modifications may be combined with one another.

### 5. Summary

The following provides supplementary description on the above embodiments and modifications.

As described in Embodiment 1, concerning the transmission device 200, the video images constituting a 3D program (i.e., left-view video images, right-view video images, and planar-view video images) are stored in the video storage unit 201.

These stored video images have the same resolution (e.g., 1920×1080) as a typical 2D broadcast. The left-view video images and the planar-view video images are compressed by the first video encoding unit 205 at the same bit rate as a typical 2D broadcast, multiplexed in the same format as a typical 2D broadcast, and transmitted as a broadcast wave by the first transmission unit 212.

The right-view video images are compressed by the second video encoding unit 206, multiplexed by the second multiplex processing unit 209, and transmitted by the second transmission unit 213 via the IP network.

This method is advantageous for the following reasons. Firstly, transmission of the left-view video images used for 2D display is performed without changing a typical broadcast system. Secondly, since the right-view video image are transmitted as an independent transport stream differing from a broadcast wave, the bit rate used for the left-view video images are not changed (i.e., the quality of the left-view video images is not deteriorated).

Also, while a typical broadcast requires the use of an old compression technique such as MPEG-2 Video, the right-view video images transmitted via the IP network can be compressed with use of a new compression technique with higher compression efficiency, such as MPEG-4 AVC. Accordingly, in a case where the planar-view video images for a commercial message or the like are transmitted using both a broadcast wave and the IP network, the planar-view video images transmitted via the IP network may have higher quality than the planar-view video images transmitted as the broadcast, depending on the bit rate of the planar-view video images transmitted via the IP network.

In such a case, 2D playback may be performed with use of the planar-view video images transmitted via the IP network (i.e., video images decoded by the second video decoding unit 307) instead of using the planar-view video images decoded by the first video decoding unit 306a as described in Embodiment 2. This allows for viewing of the commercial message or the like in higher image quality.

### 6. Supplemental Remarks

(1) An aspect of the present invention is a playback device comprising: a first reception unit configured to receive a first transport stream, the first transport stream including a series of at least one first-type video image and at least one second-type video image, the first-type video image having been encoded and being used for 3D playback, and the second-type video image having been encoded and being used for 2D playback; a second reception unit configured to receive a second transport stream including at least one third-type video image that has been encoded, the third-type video image differing from the first-type video image in terms of viewpoint and being used with the first-type video image for 3D playback; a first decoding unit configured to decode the first-type video image and the second-type video image in the first transport stream, and to store the first-type video image and the second-type video image thus decoded into a first buffer; a second decoding unit configured to decode the third-type video image in the second transport stream, and to store the third-type video image thus decoded into a second buffer; a determination unit configured to determine, for each video image in the first transport stream, whether the video image is the first-type video image or the second-type video image; and a playback processing unit configured to, when the determination unit determines that the video image is the first-type video image, perform 3D playback with use of the first-type video image stored in the first buffer and the third-type video image stored in the second buffer, and when the determination unit determines that the video image is the second-type video image, perform 2D playback with use of the second-type video image stored in the first buffer.

According to the above structure, the playback device performs 2D playback using the second-type video image stored in the first buffer. This eliminates the need for alternately switching the frame buffers. As a result, the playback device can playback (display) the video images intended for 2D display without performing a redundant process.

(2) Here, each of the video images in the first transport stream may be associated with identification information indicating whether the video image is the first-type video image or the second-type video image; and the determination unit may determine whether the video image is the first-type video image or the second-type video image, with use of the identification information associated with the video image.

According to the above structure, the playback device can determine, for each video image in the first transport stream, whether the video image is the first-type video image or the second-type video image, with use of the identification information associated with each of the video images in the first transport stream.

(3) Here, the second transport stream may further include at least one same viewpoint video image having the same viewpoint as the second-type video image included in the first transport stream, the determination unit may be further configured to, when having determined that the video image is the second-type video image, compare a quality of the second-type video image with a quality of the same viewpoint video image, and when the determination unit determines that the second-type video image has lower quality, the playback processing unit may perform 2D playback with use of the same viewpoint video image stored in the second buffer instead of the second-type video image stored in the first buffer, and when the determination unit determines that the second-type video image has higher quality, the playback processing unit may perform 2D playback with use of the second-type video image stored in the first buffer.

According to the above structure, the playback device compares the quality of the second-type video image in the first transport stream with the quality of the same viewpoint video image in the second transport stream, and performs 2D playback with use of the video image having higher quality. As a result, the viewer can enjoy viewing the video image having higher quality between the second-type video image and the same viewpoint video image having the same viewpoint as the second-type video image.

(4) Here, the second-type video image may be associated with quality information indicating whether the second-type video image has higher quality than the same viewpoint video image, and the determination unit may perform the comparison with use of the quality information.

According to the above structure, the playback device can compare image qualities with use of the quality information.

(5) Here, the second transport stream may further include a same viewpoint video image having the same viewpoint as the second-type video image included in the first transport stream, the first transport stream and the second transport stream may constitute a 3D program, the first transport stream may further include playback information indicating whether to use the second-type video image or the same viewpoint video image for 2D playback of the 3D program, and the determination unit may be further configured to, when having determined that the video image is the second-type video image, determine whether to use the second-type video image or the same viewpoint video image for the 2D playback, with use of the playback information, and when the determination unit determines that the second-type video image is to be used, the playback processing unit may perform the 2D playback with use of the second-type video image stored in the first buffer, and when the determination unit determines that the same viewpoint video image is to be used, the playback processing unit may perform the 2D playback with use of the same viewpoint video image stored in the second buffer instead of the second-type video image stored in the first buffer.

According to the above structure, the playback device can perform 2D playback with use of the video image specified by the playback information, which is either the second-type video image in the first transport stream or the same viewpoint video image in the second transport stream. For example, the provider of the 3D program can use the playback information to specify which video image to present to the viewer between the second-type video image and the same viewpoint video image.

(6) Here, the second transport stream may further include a same viewpoint video image having the same viewpoint as the second-type video image included in the first transport stream, the first transport stream and the second transport stream may constitute a 3D program, the first transport stream may further include a PMT (Program Map Table) or a VCT (Virtual Channel Table), the PMT and the VCT may each include playback information indicating whether to use the second-type video image or the same viewpoint video image for 2D playback of the 3D program, and the determination unit may be further configured to, when having determined that the video image is the second-type video image, determine whether to use the second-type video image or the same viewpoint video image for the 2D playback, with use of the playback information included in the PMT or the VCT, and when the determination unit determines that the second-type video image is to be used, the playback processing unit may perform the 2D playback with use of the second-type video image stored in the first buffer, and when the determination unit determines that the same viewpoint video image is to be used, the playback processing unit may perform the 2D playback with use of the same viewpoint video image stored in the second buffer instead of the second-type video image stored in the first buffer.

According to the above structure, for each interval specified by the PMT or the VCT, the playback device can perform 2D playback with use of the video images specified by the playback information, which are either second-type video images included in the first transport stream or same viewpoint video images included in the second transport stream.

(7) Here, the playback device may further comprise an instruction reception unit configured to receive a switching instruction indicating switching from 3D playback using the first-type video image and the third-type video image to 2D playback using either the first-type video image or the third-type video image, wherein the determination unit may be further configured to determine whether to use the first-type video image or the third-type video image for 2D playback when the instruction reception unit receives the switching instruction, and when the instruction reception unit receives the switching instruction, the playback processing unit may perform 2D playback according to a result of the determination by the determination unit.

According to the above structure, upon receiving the switching instruction, the playback device can perform 2D playback with use of either the first-type video image or the third-type video image.

(8) Here, the first-type video image included in the first transport stream may be provided in a plurality, the third-type video image included in the second transport stream may be provided in a plurality, the first-type video images may be associated one-to-one with pieces of quality information, each of the pieces of quality information indicating whether the first-type video image has higher quality than the corresponding third-type video image, and when the piece of quality information associated with each of the first-type video images indicates that the first-type video image has higher quality than the corresponding third-type video image, the determination unit may determine that 2D playback is performed with use of the first-type video image, and when the piece of quality information indicates that the first-type video image has lower quality than the corresponding third-type video image, the determination unit may determine that 2D playback is performed with use of the corresponding third-type video image.

According to the above structure, upon receiving the switching instruction, the playback device can perform 2D playback with use of the video images having higher quality between the first-type video images and the third-type video images, based on the pieces of quality information. As a result, during 2D playback, the viewer can enjoy viewing the video images having higher quality between the first-type video images and the third-type video images.

(9) Here, the determination unit may be further configured to compare a quality of the first-type video image with a quality of the third-type video image, and when having determined that the first-type video image has higher quality, the determination unit may determine that 2D playback is performed with use of the first-type video image, and when having determined that the third-type video image has higher quality than the first-type video image, the determination unit may determine that 2D playback is performed with use of the third-type video image.

According to the above structure, upon receiving the switching instruction, the playback device can compare the quality of the first-type video image with the quality of the third-type video image, and can perform 2D playback with use of the video image having higher quality therebetween.

(10) Here, the first-type video image included in the first transport stream may be provided in a plurality, the third-type video image included in the second transport stream may be provided in a plurality, the plurality of first-type video images and the plurality of third-type video images may constitute a 3D program, the first transport stream may include playback information indicating whether to use the first-type video images or the third-type video images for the 3D program when 3D playback is switched to 2D playback, and the determination unit may be further configured to determine whether to use the first-type video images or the third-type video images for 2D playback with use of the playback information, when the instruction reception unit receives the switching instruction.

According to the above structure, the playback device can perform 2D playback with use of either the first-type video images in the first transport stream or the third-type video images in the second transport stream specified by the playback information. For example, the provider of the 3D program can use the playback information for the 3D program to specify which video images to present to the viewer between the first-type video images and the third-type video images.

(11) Here, the first-type video image included in the first transport stream may be provided in a plurality, the third-type video image included in the second transport stream may be provided in a plurality, the plurality of first-type video images and the plurality of third-type video images may constitute a 3D program, the first transport stream may further include a PMT (Program Map Table) or a VCT (Virtual Channel Table), the PMT and the VCT may each include playback information indicating whether to use the first-type video images or the third-type video images for the 3D program when 2D playback is performed, and the determination unit may be further configured to determine whether to use the first-type video images or the third-type video images for 2D playback with use of the playback information included in the PMT or the VCT, when the instruction reception unit receives the switching instruction for the 3D program.

According to the above structure, for each interval specified by the PMT or the VCT, the playback device can perform 2D playback with use of the video images specified by the playback information, which are either the first-type video images in the first transport stream or the third-type video images in the second transport stream.

(12) Here, during 3D playback, the playback processing unit may read each of the first-type video image stored in the first buffer and the third-type video image stored in the second buffer once at a different timing during a predetermined period, and may display the first-type video image and the second-type video image, and during 2D playback, the playback processing unit may read the second-type video image stored in the first buffer twice at different timings during the predetermined period.

According to the above structure, the playback device can perform 2D playback by reading the second-type video image stored in the first buffer twice.

(13) An aspect of the present invention is a transmission device comprising: a first storage unit configured to store a first transport stream including a first-type video image, a second-type video image, and video identifiers, the first-type video image having been encoded and being used for 3D playback, the second-type video image having been encoded and being used for 2D playback, and each of the video identifiers corresponding to a different one of the first-type video image and the second-type video image and identifying whether the corresponding video image is the first-type video image or the second-type video image; a second storage unit configured to store a second transport stream including a third-type video image that has been encoded, the third-type video image differing from the first-type video image in terms of viewpoint, and being used with the first-type video image for stereoscopic viewing during 3D playback; a first transmission unit configured to transmit the first transport stream; and a second transmission unit configured to transmit the second transport stream.

According to the above structure, the transmission device can transmit the first transport stream including the video images associated with the respective video identifiers. This allows a reception device to determine, for each of the video images in the first transport stream, whether the video image is the first-type video image or the second-type video image, with use of the corresponding video identifier.

(14) Here, the first-type video image and the second-type video image included in the first transport stream may be each provided in a plurality, the second transport stream may further include same viewpoint video images having the same viewpoint as the second-type video images included in the first transport stream, and the first transport stream may further include pieces of quality information corresponding one-to-one to the second-type video images, each of the pieces of quality information indicating whether the second-type video image has higher quality than the corresponding same viewpoint video image.

According to the above structure, the transmission device transmits the first transport stream including the pieces of quality information corresponding one-to-one to the second-type video images. This allows a reception device to determine, for each of the second-type video images, whether the second-type video image has higher quality than the corresponding same viewpoint video image in the second transport stream, with use of the piece of quality information corresponding to the second-type video image.

(15) Here, the first-type video image included in the first transport stream may be provided in a plurality, the third-type video image included in the second transport stream may be provided in a plurality, and the first transport stream may further include pieces of quality information corresponding one-to-one to the first-type video images, each of the pieces of quality information indicating whether the first-type video image has higher quality than the corresponding third-type video image.

According to the above structure, the transmission device transmits the first transport stream including the pieces of quality information corresponding one-to-one to the first-type video images. This allows a reception device to determine, for each of the first-type video images, whether the first-type video image has higher quality than the corresponding third-type video image in the second transport stream, with use of the piece of quality information corresponding to the first-type video image, and to perform 2D playback using the video image having higher quality.

### INDUSTRIAL APPLICABILITY

The transmission device and the playback device according to the present invention are respectively applicable to a device that transmits a 3D program using two independent transport streams and a device that receives and plays back such transport streams.

### REFERENCE SIGNS LIST

10, 10a, 10b playback device
200, 200a, 200b transmission device
201 video storage unit
202 stream management information storage unit
203 subtitle stream storage unit
204 audio stream storage unit
205, 205a, 205b first video encoding unit
206, 206a second video encoding unit
207 video stream storage unit
208 first multiplex processing unit
209 second multiplex processing unit
210 first transport stream storage unit
211 second transport stream storage unit
212 first transmission unit
213 second transmission unit
301 tuner
302 NIC
303, 303b user interface unit
304 first demultiplexing unit
305 second demultiplexing unit
306, 306a, 306b first video decoding unit
307 second video decoding unit
308 subtitle decoding unit
309 OSD creation unit
310 audio decoding unit
311, 311a, 311b determination unit
312, 312a, 312b playback processing unit
313 speaker
321 first frame buffer
322 second frame buffer
323 frame buffer switching unit
324, 324a, 324b switching control unit
325 superimposition unit
326 display unit
1000 video transmission and reception system

1. A playback device comprising:
a first reception unit configured to receive a first transport stream, the first transport stream including a series of at least one first-type video image and at least one second-type video image, the first-type video image having been encoded and being used for 3D playback, and the second-type video image having been encoded and being used for 2D playback;
a second reception unit configured to receive a second transport stream including at least one third-type video image that has been encoded, the third-type video image differing from the first-type video image in terms of viewpoint and being used with the first-type video image for 3D playback;
a first decoding unit configured to decode the first-type video image and the second-type video image in the first transport stream, and to store the first-type video image and the second-type video image thus decoded into a first buffer;
a second decoding unit configured to decode the third-type video image in the second transport stream, and to store the third-type video image thus decoded into a second buffer;
a determination unit configured to determine, for each video image in the first transport stream, whether the video image is the first-type video image or the second-type video image; and
a playback processing unit configured to, when the determination unit determines that the video image is the first-type video image, perform 3D playback with use of the first-type video image stored in the first buffer and the third-type video image stored in the second buffer, and when the determination unit determines that the video image is the second-type video image, perform 2D playback with use of the second-type video image stored in the first buffer.

2. The playback device of claim 1, wherein
each of the video images in the first transport stream is associated with identification information indicating whether the video image is the first-type video image or the second-type video image; and
the determination unit determines whether the video image is the first-type video image or the second-type video image, with use of the identification information associated with the video image.

3. The playback device of claim 2, wherein
the second transport stream further includes at least one same viewpoint video image having the same viewpoint as the second-type video image included in the first transport stream,
the determination unit is further configured to, when having determined that the video image is the second-type video image, compare a quality of the second-type video image with a quality of the same viewpoint video image, and
when the determination unit determines that the second-type video image has lower quality, the playback processing unit performs 2D playback with use of the same viewpoint video image stored in the second buffer instead of the second-type video image stored in the first buffer, and when the determination unit determines that the second-type video image has higher quality, the playback processing unit performs 2D playback with use of the second-type video image stored in the first buffer.

4. The playback device of claim 3, wherein
the second-type video image is associated with quality information indicating whether the second-type video image has higher quality than the same viewpoint video image, and
the determination unit performs the comparison with use of the quality information.

5. The playback device of claim 2, wherein
the second transport stream further includes a same viewpoint video image having the same viewpoint as the second-type video image included in the first transport stream,
the first transport stream and the second transport stream constitute a 3D program,
the first transport stream further includes playback information indicating whether to use the second-type video image or the same viewpoint video image for 2D playback of the 3D program, and
the determination unit is further configured to, when having determined that the video image is the second-type video image, determine whether to use the second-type video image or the same viewpoint video image for the 2D playback, with use of the playback information, and
when the determination unit determines that the second-type video image is to be used, the playback processing unit performs the 2D playback with use of the second-type video image stored in the first buffer, and when the determination unit determines that the same viewpoint video image is to be used, the playback processing unit performs the 2D playback with use of the same viewpoint video image stored in the second buffer instead of the second-type video image stored in the first buffer.

6. The playback device of claim 2, wherein
the second transport stream further includes a same viewpoint video image having the same viewpoint as the second-type video image included in the first transport stream,
the first transport stream and the second transport stream constitute a 3D program,
the first transport stream further includes a PMT (Program Map Table) or a VCT (Virtual Channel Table),
the PMT and the VCT each include playback information indicating whether to use the second-type video image or the same viewpoint video image for 2D playback of the 3D program, and
the determination unit is further configured to, when having determined that the video image is the second-type video image, determine whether to use the second-type video image or the same viewpoint video image for the 2D playback, with use of the playback information included in the PMT or the VCT, and
when the determination unit determines that the second-type video image is to be used, the playback processing unit performs the 2D playback with use of the second-type video image stored in the first buffer, and when the determination unit determines that the same viewpoint video image is to be used, the playback processing unit performs the 2D playback with use of the same viewpoint video image stored in the second buffer instead of the second-type video image stored in the first buffer.

7. The playback device of claim 1, further comprising
an instruction reception unit configured to receive a switching instruction indicating switching from 3D playback using the first-type video image and the third-type video image to 2D playback using either the first-type video image or the third-type video image, wherein
the determination unit is further configured to determine whether to use the first-type video image or the third-type video image for 2D playback when the instruction reception unit receives the switching instruction, and
when the instruction reception unit receives the switching instruction, the playback processing unit performs 2D playback according to a result of the determination by the determination unit.

8. The playback device of claim 7, wherein
the first-type video image included in the first transport stream is provided in a plurality,
the third-type video image included in the second transport stream is provided in a plurality,
the first-type video images are associated one-to-one with pieces of quality information, each of the pieces of quality information indicating whether the first-type video image has higher quality than the corresponding third-type video image, and
when the piece of quality information associated with each of the first-type video images indicates that the first-type video image has higher quality than the corresponding third-type video image, the determination unit determines that 2D playback is performed with use of the first-type video image, and when the piece of quality information indicates that the first-type video image has lower quality than the corresponding third-type video image, the determination unit determines that 2D playback is performed with use of the corresponding third-type video image.

9. The playback device of claim 7, wherein
the determination unit is further configured to compare a quality of the first-type video image with a quality of the third-type video image, and
when having determined that the first-type video image has higher quality, the determination unit determines that 2D playback is performed with use of the first-type video image, and when having determined that the third-type video image has higher quality than the first-type video image, the determination unit determines that 2D playback is performed with use of the third-type video image.

10. The playback device of claim 7, wherein
the first-type video image included in the first transport stream is provided in a plurality,
the third-type video image included in the second transport stream is provided in a plurality,
the plurality of first-type video images and the plurality of third-type video images constitute a 3D program,
the first transport stream includes playback information indicating whether to use the first-type video images or the third-type video images for the 3D program when 3D playback is switched to 2D playback, and
the determination unit is further configured to determine whether to use the first-type video images or the third-type video images for 2D playback with use of the playback information, when the instruction reception unit receives the switching instruction.

11. The playback device of claim 7, wherein
the first-type video image included in the first transport stream is provided in a plurality,
the third-type video image included in the second transport stream is provided in a plurality,
the plurality of first-type video images and the plurality of third-type video images constitute a 3D program,
the first transport stream further includes a PMT (Program Map Table) or a VCT (Virtual Channel Table),
the PMT and the VCT each include playback information indicating whether to use the first-type video images or the third-type video images for the 3D program when 2D playback is performed, and
the determination unit is further configured to determine whether to use the first-type video images or the third-type video images for 2D playback with use of the playback information included in the PMT or the VCT, when the instruction reception unit receives the switching instruction for the 3D program.

12. The playback device of claim 1, wherein
during 3D playback, the playback processing unit reads each of the first-type video image stored in the first buffer and the third-type video image stored in the second buffer once at a different timing during a predetermined period, and displays the first-type video image and the second-type video image, and
during 2D playback, the playback processing unit reads the second-type video image stored in the first buffer twice at different timings during the predetermined period.

13. A transmission device comprising:
a first storage unit configured to store a first transport stream including a first-type video image, a second-type video image, and video identifiers, the first-type video image having been encoded and being used for 3D playback, the second-type video image having been encoded and being used for 2D playback, and each of the video identifiers corresponding to a different one of the first-type video image and the second-type video image and identifying whether the corresponding video image is the first-type video image or the second-type video image;
a second storage unit configured to store a second transport stream including a third-type video image that has been encoded, the third-type video image differing from the first-type video image in terms of viewpoint, and being used with the first-type video image for stereoscopic viewing during 3D playback;
a first transmission unit configured to transmit the first transport stream; and
a second transmission unit configured to transmit the second transport stream.

14. The transmission device of claim 13, wherein
the first-type video image and the second-type video image included in the first transport stream are each provided in a plurality,
the second transport stream further includes same viewpoint video images having the same viewpoint as the second-type video images included in the first transport stream, and
the first transport stream further includes pieces of quality information corresponding one-to-one to the second-type video images, each of the pieces of quality information indicating whether the second-type video image has higher quality than the corresponding same viewpoint video image.

15. The transmission device of claim 13, wherein
the first-type video image included in the first transport stream is provided in a plurality,
the third-type video image included in the second transport stream is provided in a plurality, and
the first transport stream further includes pieces of quality information corresponding one-to-one to the first-type video images, each of the pieces of quality information indicating whether the first-type video image has higher quality than the corresponding third-type video image.

16. A playback method used in a playback device comprising:
a first reception step of receiving a first transport stream, the first transport stream including a series of at least one first-type video image and at least one second-type video image, the first-type video image having been encoded and being used for 3D playback, and the second-type video image having been encoded and being used for 2D playback;
a second reception step of receiving a second transport stream including at least one third-type video image that has been encoded, the third-type video image differing from the first-type video image in terms of viewpoint and being used with the first-type video image for 3D playback;
a first decoding step of decoding the first-type video image and the second-type video image in the first transport stream, and of storing the first-type video image and the second-type video image thus decoded into a first buffer;
a second decoding step of decoding the third-type video image in the second transport stream, and of storing the third-type video image thus decoded into a second buffer;
a determination step of determining, for each video image in the first transport stream, whether the video image is the first-type video image or the second-type video image; and
a playback processing step of, when the determination step determines that the video image is the first-type video image, performing 3D playback with use of the first-type video image stored in the first buffer and the third-type video image stored in the second buffer, and when the determination step determines that the video image is the second-type video image, performing 2D playback with use of the second-type video image stored in the first buffer.

17. A transmission method used in a transmission device including: a first storage unit that stores a first transport stream including a first-type video image, a second-type video image, and video identifiers, the first-type video image having been encoded and being used for 3D playback, the second-type video image having been encoded and being used for 2D playback, and each of the video identifiers corresponding to a different one of the first-type video image and the second-type video image and identifying whether the corresponding video image is the first-type video image or the second-type video image; and a second storage unit that stores a second transport stream including a third-type video image, the third-type video image having been encoded, differing from the first-type video image in terms of viewpoint, and being used with the first-type video image for stereoscopic viewing during 3D playback, the transmission method comprising the steps of:
transmitting the first transport stream; and
transmitting the second transport stream.
